(19) United States
(12) Patent Application Publication
(10) Pub. No.: US 2002/0035504 A1
(43) Pub. Date: Mar. 21, 2002

(54) Lead suspect management

(76) Inventors: Alyssa Dver, Ashland, MA (US); Michael Krantz, King of Prussia, PA (US); Jack B. Murphy, Trumbauersvl, PA (US); Robert A. Gephart, York, PA (US); Marco A. Emrich, Phoenixville, PA (US)

Correspondence Address: Rochelle Lieberman, Esq., Lieberman & Brandsdorfer, LLC, 12221 McDonald Chapel Drive, Gaithersburg, MD, 20878, US

(21) Appl. No.: 09/985,973

(22) Filed: Nov. 7, 2001

Related U.S. Application Data
(63) Continuation-in-part of application No. 09/639,740, filed on Aug. 16, 2000.

(51) Int. Cl. G06F 17/60

(52) U.S. Cl. 705/10

(57) ABSTRACT

A method and system for marketing products and/or services to a database of records. The system includes workflow parameters in the form of stations. Each station defines an action and a set time interval for conducting the action on a record in the station. In addition, each station provides a selection of subsequent stations for the record following the performance of the action by the selected user. In addition, the user may select to generate a report on the records of the database based upon the fields of the records. The report may also be in the form of an automatically generated report produced at a defined interval. The workflow parameters may be customized by a system administrator to meet the needs of different users. Accordingly, the workflow provides an automated and organized method of managing sales and marketing leads.

### CROSS REFERENCE TO RELATED APPLICATION(S)

This is a continuation-in-part patent application claiming benefit of the filing date of U.S. patent application Ser. No. 09/639,740 filed Aug. 16, 2000, and titled “Lead Suspect Management”, which is hereby incorporated herein by reference.

### NOTICE OF COPYRIGHTED MATERIAL IN DISCLOSURE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

1. Field of the Invention

The invention relates to a method and apparatus for effectively tracking prospective customers and contacts. More specifically, the invention relates to a system for a computer implemented algorithm which enables marketing personnel to track prospective customers and contacts through the use of a centralized database and to calendar specific periods in which contact should be initiated with prospective customers or contacts in addition to determining at which juncture a customer, prospective customer or contact should be forwarded to a sales associate, removed from the database, placed in a hold status or have an action taken with regard to that customer, prospective customer or contact.

2. Description of Related Technology

In order to support effective targeted marketing, a provider of products and/or services must know its customer and target market. Knowing one's customers and target market is also important for improved sales and for getting new customers and keeping existing customers. Since knowing one's customers and target market becomes more difficult when the number of customers and potential customers increases and the frequency of each customer's and potential customer's contact with a particular employee decreases, the size of a customer base can present an obstacle to some marketing efforts. It is also important to maintain an active data base with a workflow management for tracking and managing all potential sales and marketing Leads. In the fast paced marketplace of today, it is difficult to track and ascertain the needs of the customers and potential customers and to provide targeted marketing opportunities. Accordingly, there is a need to provide a product which assists in providing effective and targeted marketing and takes a potential or existing customer or marketing Lead all the way through from first contact to a sale of the products and/or services.

A. Databases

In an effort to deal with a large customer database, businesses traditionally maintain customer records. In some cases these records are in the form of simple paper records, but recently electronic records have become common in the industry. Originally, separate data storage was used for each electronic record keeping application. Thus, each department in a corporation would have a software program that created and maintained records needed for its specific purpose, i.e. sales and marketing. The problem with this approach is that information must be extensively duplicated. For example, a customer's name and address might appear in separate files in several different departments. Accordingly, maintaining separate electronic records for different departments is not only expensive and time consuming, but it does not provide a central system for managing marketing and sales Leads.

There are other problems with application specific data storage. Since a customer's information is entered in more than one file, any change in status must be entered into each file, often by different people. Over time the accuracy and uniformity of the data deteriorates. For example, a person in the marketing department for one product may update their database, but a person marketing a second product may not update their database. In addition to the problems associated with duplication errors, the use of application specific data storage requires more data entry and more storage space. Accordingly, application specific data storage can become very expensive to acquire and maintain.

Databases for maintaining records have been around for nearly a quarter of a century and have come a long way toward eliminating problems associated with specific data storage. In a modem database, data is stored in a central location so that duplication of data does not occur. Database management programs and algorithms are used to manage databases. Typically, a database management system (DBMS) is used to manage the creation, storage, access, updating, deletion, and all facets of use of a database. A typical DBMS creates databases and their structures; provides the means for the control and administration of the data in the database; provides the means for users and application programs to access, enter, modify, and manipulate the data in a database; provides a report generator; provides “ad hoc” query facilities; provides reports to management on who accessed the database and what activity was performed; provides reports to operators on hardware utilization, status of current users, and other monitoring data; and provides automatic backup and recovery routines for the data in the database.

B. Database Models

There are four basic database models: (1) hierarchical, (2) network, (3) relational, and (4) object oriented. The hierarchical and network models use files for storing data. Data relationships in the hierarchical databases follow hierarchical, or tree structure, which reflect either a one-to-one or a one-to-many relationship among the record types. Data relationships in network databases follow a many-to-many relationship among the records. The data relationships must be defined at the time that a hierarchical or network database is created. Relational databases use tables for storing data. The data relationships can be dynamically determined by the users and do not have to be defined when the database is created. A relational database uses a database query language for users to access and manipulate data in the database.

Object oriented databases store data together with procedures in objects.

For purposes of this discussion, we will focus on relational databases. A relational database is composed of many tables in which data is stored. Tables in a relational database must have unique rows, and each cell or field must contain only one item of information, such as a name, address or an identification number or marker. A relational database system allows data to be readily created, maintained, manipulated, and retrieved. Accordingly, a relational database system is desirable for an application adapted to track sales and marketing Leads for specific products and for effectively and efficiently conducting a marketing.

In most sophisticated relational databases data is retrieved by querying the database. Query languages allow users to locate specific records based on the data that the specific record contains. In this manner, the specific data relationships do not have to be predefined. Users may query a relational database and establish data relationships spontaneously by joining common fields. A database query language acts as an interface between users and a relational DBMS. Accordingly, the database query language used in a sophisticated relational database permits the spontaneous creation of relationships between database fields.

There are essentially two basic query styles used in a relational database query by example and structured query language (SQL). In query by example, the DBMS displays field information and users enter inquiry conditions in the desired fields. Currently SQL is the standard database query language used with relational databases. SQL is a database language component of a DBMS, not a separate stand-alone software program. SQL allows users to create and operate sets of related information that are stored in tables and allows users to describe data the user wishes to see. SQL also allows the users to define the data in a database and manipulate the data. Accordingly, the use of SQL in a DBMS provides the necessary capabilities for a relational database to utilize the data stored in the database's tables.

The central function and major utility of SQL is its flexibility in how a database is queried. Since data in relational databases is stored in tables that have specific properties, the flexibility required to manipulate and create dynamic data field relationships is provided and made possible by SQL. These specific properties include: (1) one or more named columns, (2) data in each column being of the same type, (3) zero or more rows within the table (zero rows occur when the table is defined but no data is entered yet), (4) every row is unique, (5) a single data value is contained in the intersection of any column and row, and (6) the order of the columns and rows does not matter.

C. Retrieving Data from a Database

There are two basic schemes for retrieving data from a database: set orientation and record orientation. Each method has advantages and disadvantages.

A set oriented database allows the user to focus on the characteristics of the data rather than the physical structure of the data. The user works with data in groups, sets, or tables, rather than as individual tables. Examples of set oriented databases are Microsoft SQL Server, Oracle, Sybase, Informix, Access, and SQL Base. Record oriented databases access data based on the physical structure of data indexing. A record point permits the user to maneuver through a table one record at a time. It is easy to access successive rows or records in a table. However, the developer of the DBMS must write the programing code such that it will loop through every record requested in order to function properly. The requirement that one loop through every record of the table is a substantial disadvantage for the record oriented scheme. Accordingly, the use of a set orientation scheme for retrieving data has a substantial advantage over that of the record oriented scheme.

(d) Database Security

In an DBMS, security is maintained by granting authority to an administrator or other users of the system. Authority may be granted to access the entire database, certain tables within the database, or certain commands. At least one individual must act as a database administrator who must have access to the entire database so that the database will be properly maintained. However, users are generally granted access to specific tables or parts of tables to perform their required functions. Accordingly, maintaining security provides for a hierarchy of access rights to the database and may allow for a division of responsibilities between users.

### SUMMARY OF THE INVENTION

It is therefore an object of the present invention to provide a system for tracking and managing sales and marketing Leads that provides an organized and effective manner of targeting prospective clients and/or customers using a centralized database. More specifically, the present invention is directed to a system that allows a sales and marketing team to take advantage of a centralized database which focuses on management of these Leads.

A first aspect of the invention is a method for marketing. A plurality of records are created in a database, and a workflow parameter is customized. The records in the database are managed within the workflow parameter. The workflow includes stations, and each station is assigned a duration in which a record may remain in the station, an action to be conducted by a user upon the record in the station, as well as a subsequent station(s) for the record following the set duration. In addition, reports of the records in the database can be compiled. The parameters of the report are selected from the fields of the record. Automatically generated reports may also be generated based upon selected fields of the record. A frequency for generating automatically generated reports may be set. In addition, a medium for communicating both reports and automatically generated reports may be selected from the group consisting of: electronic mail, a print copy, and a hyperlink to a browser page. An opportunity may be created within the workflow for marketing an item. The opportunity includes the workflow parameters for a specific product and/or service. The parameters of the campaign may be amended. Each record in the database is defined by an originating source. The originating source provides a selection of originating stations in the workflow. In addition, records and users may be removed from the database. The process of removing users from the database includes reassigning records from the user to another user. Finally, records may individually be placed in the database or they may be imported from an source. The process of importing records from an external source includes creating a file import map in within the parameters of the database.

A second aspect of the invention is a computer system for marketing. The system includes a database and a plurality of records in the database, a workflow parameters that is adapted to be customized, and a workflow parameters to manage the records of the database. An instruction is provided to process records through the workflow. The workflow parameter is a duration for a record to remain in a station. The workflow parameter also defines an action to be conducted by a user of the database upon the record during the duration. Each workflow indicates a subsequent station for the record. The system also has an instruction to compile a report of the records in the database. The report may include parameters selected from the fields of the records. In addition, the system can create an automatically generated report, which produces a specified report within a provided frequency. Both the report and the automatically generated reports may be communicated in a medium selected from the group consisting of: electronic mail, a print copy, and a hyperlink to a browser page. The system also includes an instruction to create an opportunity with the workflow to market an item(s). In addition, each record in the database is defined by an originating source, which assigns a selection of originating stations to the records in the workflow. Records, users and sources may be removed from the database. The process of removing users from the database includes an instruction to reassign records from the user to another user. Finally, records may individually be placed in the database or they may be imported from an external source. The process of importing records from an external source includes creating a file import map in within the parameters of the database.

Other features and advantages of this invention will become apparent from the following detailed description of the presently preferred embodiment of the invention, taken in conjunction with the accompanying drawings.

### BRIEF DESCRIPTION OF THE DRAWINGS

The accompanying drawings provide a further understanding of the invention and are incorporated in and constitute a part of this specification. The drawings illustrate preferred embodiments of the invention and, together with the description, serve to explain the principles of the invention.

FIG. 1 is a sample front page of the system.

FIG. 2 is a sample page for an administrator.

FIG. 3 is a flow chart illustrating the process for removing a source from the system.

FIG. 4 is a flow chart illustrating the process for creating a new source in the system.

FIG. 5 is a flow chart illustrating the process of manually entering leads into the system.

FIG. 6 is a flow chart illustrating the process of importing leads into the system.

FIG. 7 is a flow chart illustrating the process of creating an import map for the system.

FIG. 8 is a flow chart illustrating the process of amending an import map in the system.

FIG. 9 is a flow chart illustrating the process of exporting data from the system.

FIG. 10 is a flow chart illustrating the process for searching for leads previously entered in the system.

FIG. 11 is a flow chart for generating a report in the system.

FIG. 12 is a flow chart illustrating the process of creating a new auto-generating report in the system.

FIG. 13 is a flow chart for amending an auto-generated report in the system.

FIG. 14 is a flow chart illustrating the process of editing company identification information in the system.

FIG. 15 is a flow chart illustrating the process of creating a new in the system.

FIG. 16 is a flow chart illustrating the process for editing an opportunity in the system.

FIG. 17 is a flow chart illustrating the process for removing an opportunity from the system.

FIG. 18 is a flow chart illustrating the process for creating a new user account in the system.

FIG. 19 is a flow chart illustrating the process for editing a user account from the system.

FIG. 20 is a flow chart illustrating the process for removing user accounts from the system.

FIG. 21 is a flow chart illustrating the process for creating a new station from the system.

FIG. 22 is a flow chart illustrating the process for editing station parameters.

FIG. 23 is a flow chart illustrating the process for creating a new station action in the system.

FIG. 24 is a flow chart illustrating the process for amending a station action in the system.

FIG. 25 is a flow chart illustrating the process for editing the system workflow and amending the order of station actions.

FIG. 26 is a flow chart illustrating the process for removing a station action from the system.

FIG. 27 is a flow chart illustrating the process for managing the process for resolving duplicate leads in the system.

FIG. 28 is a flow chart illustrating the process for removing a lead from the system.

FIG. 29 is a flow chart illustrating the process for removing auto-generated reports from the system.

FIG. 30 is a flow chart illustrating the process for a user managing leads in the system according to the preferred embodiment of this invention, and is suggested for printing on the first page of the issued patent.

### DETAILED DESCRIPTION OF THE PREFERRED EMBODIMENT

AND BEST MODE OF THE INVENTION

References will now be made in detail to a preferred embodiment of the invention, an example of which is illustrated in the accompanying drawings. The system includes a central database with a plurality of workstations. These components are connected together through telecommunication links or an equivalent connecting element that allows the workstations to electronically communicate with the central database. In a preferred embodiment, the database is maintained on a server and all users may access the server via a global computer network, such as the Internet. For purposes of explaining the invention in detail, the invention will be described for marketing personnel and prospective customers. However, it should be understood by those skilled in the art that the invention is not limited to a marketing opportunity, but the apparatus and method disclosed herein may be used for tracking and targeting marketing and/or sales of an array of products and/or services. Accordingly, the scope of this disclosure shall be limited to targeting customers for marketing purposes for ease of understanding the invention disclosed herein.

Structure

As used in the following description, a “Lead” is a customer or prospective customer specifically targeted for a marketing and sales effort based upon a probable need. The Lead can be self-identified, part of an ongoing effort, or part of a short term opportunity. Basic contact information for each Lead is stored in the database, such as business name, contact person, addresses, electronic mail addresses, and telephone numbers. However, the information fields should not be limited to those listed herein. Additional fields are provided for each record generated, such as source of contact, type of contact, date entered, person who entered the contact into the database, or other identifying pertinent information. These additional fields support the use of the data as it is used within the application and serve to increase the utility of the data within the database. In addition, an administrator of the system can add custom fields which are given the same capabilities as the base fields of the system, such as the ability to be searched and reported.

A “Station” as used herein is defined as a predefined workflow based on the type of Lead and required follow-up. Each predefined Station tracks the source of the Lead input, the marketing activities required for follow-up, and the sales activity once the Lead has been turned over to the sales department in view of the determination that such a transfer of the Lead is proper. Leads move from one Station to another eventually ending up as either a sale or as a rejected contact. Accordingly, the Stations define the status of a Lead in a marketing opportunity as well as further efforts which may be deemed necessary to make the Lead a possible sale or reject the Lead as not interested in the product.

A “Station Master” is a person responsible for monitoring the Leads within their assigned station, with the responsibility of ensuring that the person assigned to specific stations actively markets to the Leads in that station during the time allotted. In the event a Lead remains in a station beyond the predefined time limit, the Station Master may be responsible for taking action on each neglected Lead and ensuring that the proper action is taken on any neglected Lead to ensure that the Lead is not lost in the workflow or deviates from the parameters of the specific marketing opportunity. For all Leads that remain in a station beyond the proscribed time limit an alert is generated in the form of an electronic mail which notifies the Station Master, or an alternative user, of the tardiness. In the case where alerts are programmed to be forwarded to the Station Master, the Station Master is then provided the opportunity to actively ensure that an appropriate action is taken on the Lead. A Station Master may have a general user account or an administrative account. Accordingly, the Station Master acts as a supervisor for monitoring the activity in the station to which he or she is assigned.

Each lead entered into the database is placed in an opportunity. An opportunity is identified by a name, a start data and an end date. Furthermore, each opportunity may have a set station progression which may differ from other opportunities in the database. In essence each opportunity defines different products and services being marketed by the company. A duplicate lead may be classified in multiple concurrent opportunities. The scope of this application will include processes for defining opportunities, entering leads into opportunities, and tracking leads through an opportunity. Accordingly, by defining the parameters of each opportunity leads may be effectively targeted and marketed, and the activities of such marketing may be monitored properly.

In a preferred embodiment of the invention, the system is accessible via a global computer network, such as the internet, and is hosted by either an Internet Service Provider (“ISP”) or an Application Service Provider (“ASP”). Alternatively, the product may be hosted on a company specific server with browser front-end access via an Internet Server or a computer connected to a local area network (“Intranet Server”). The ISP, ASP, or Intranet Server is responsible for establishing and managing multiple accounts and ensuring that the database for each account remains intact and is not shared among multiple accounts. In general, the ISP, ASP, or Intranet Server establishes a new company database for each account and a superuser password for the company administrator for that account. In this way the administrator may establish user accounts within the database.

The ISP, ASP, or Intranet Server may expand the size of the database to hold a greater number of leads, retrieve passwords for the company administrator and any assigned users, delete and/or edit any necessary data profile information within the database, such as company profile, source information, and station information. Since the ISP, ASP, or Intranet Server manages all established accounts, the ISP, ASP, or Intranet Server is responsible for backing up all of the account databases, or individual company databases. Finally, the ISP, ASP, or Intranet Server may grant the authority to account administrators to roll back data input defined by a specific user and time interval. Accordingly, the ISP, ASP or Intranet Server functions as a host of the company databases to edit any default settings in the database that require change, as well as a source for storing and backing up all database information.

In a preferred embodiment, the database is secured and only allows access to account holders. Once an account has been established, a data base is available for the account, and an administrator of the account may issue user names and associated passwords. The level of security and scrutiny of the database is amendable by the administrator and by limiting access rights. Upon entering a valid username and password, the user is presented with a page for selecting different courses of action. In general, the front page will identify the user, and will allow the user to select from a menu for a course of action on a lead or leads in the database. If the user is an administrator with administrator rights and privileges, the user is presented with a page allowing selection options equivalent to that available in a general user account as well as an administration window. Accordingly, the privileges associated with an administrator will overlap with the general privileges assigned with a general account user as well as provide additional privileges for managing the database.

Account User Privileges

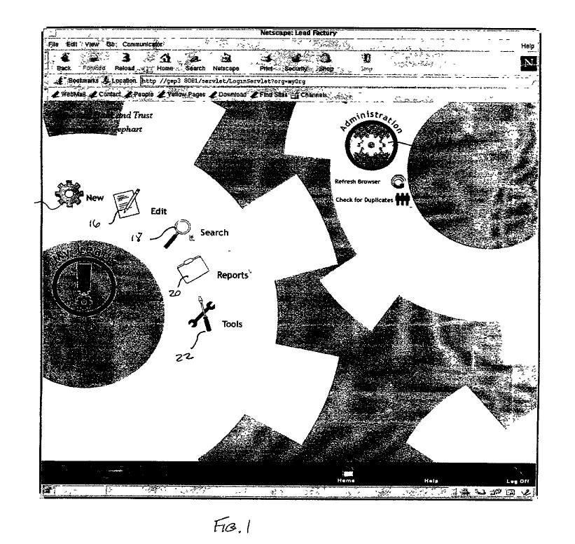

An account user who does not possess administrative privileges is provided with user options and privileges. However, as shown in FIG. 1, an administrator entering the database will be provided with a display that allows them to select from a menu of administrative functions in addition to a menu of user functions. In this regard, the user functions are the same for an account user and an administrative user and will be presented in the same manner for both. Accordingly, administrative users, once identified to the system, will have the additional functions available for selection as an addition to the already available account user functions. Unlike the display presented in FIG. 1, account users without administrative privileges will not even see the administration functions displayed. However, account users have some of their own administrative privileges, including changing their passwords, generating a list of system administrators, viewing opportunities, and viewing workflow stations and their associated definitions. Accordingly, all account user functions described herein should be considered accessible to users with administrative privileges by default and any reference to accessible functions for account users should also be considered accessible functions for administrative users.

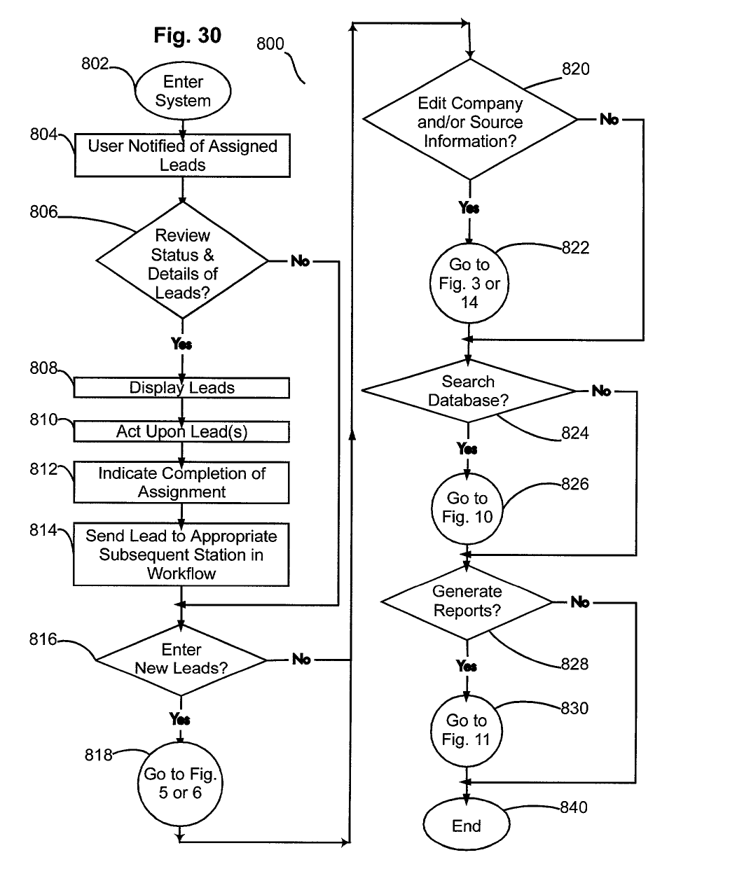

FIG. 30 is a flow chart 800 demonstrating how an account user enters the system and the menu selection option. Upon entering the system 802, the user will be notified if there are leads assigned to the user that have not been acted upon 804, 806. This is the same for user and administrators who may have the responsibility of managing leads. One example of such a method of notification is if the “my leads” icon is flashing or rotating, or otherwise creating a signal to the account user. The user may select the “my leads” icon or similarly configured field to review the status of unattended leads. Each lead that has not been acted upon will be displayed 808 in conjunction with contact information, opportunity and deadline for acting upon a lead. Once a user has acted upon the lead 810 within the parameters of the defined station, they must indicate completion of their assignment 812 and select to move the lead to an appropriate subsequent station 814 in the workflow. The assignment of a subsequent station will generally be indicative of the reaction of the lead to the account user. If the user is an administrator, the selection of the notification icon may also be indicative of tardiness of acting on leads by the assigned user. Any administrator identified as a station master is notified of such tardiness and may either act of the leads themselves or re-assign the leads to the same user or a different user. However, the user does not need to elect to act on any of the unattended leads. The user may select to undertake other actions available on the system such as entering new leads into the database 816-818, editing company and/or source information that are already in the database 820-822, searching the database 824-826, generating reports 828-830 or selecting from a menu of ancillary tools 22 which may be available. Accordingly, the process of acting upon a lead assigned to a user or administrator will result in the lead processing through the workflow.

The users function is to manage leads in the database that are assigned to them at any given time. However, the user does not have the authority to edit the parameters of an opportunity or the workflow within any given opportunity. This control is only provided to one with administrator privileges which are discussed below in the administrator privileges section.

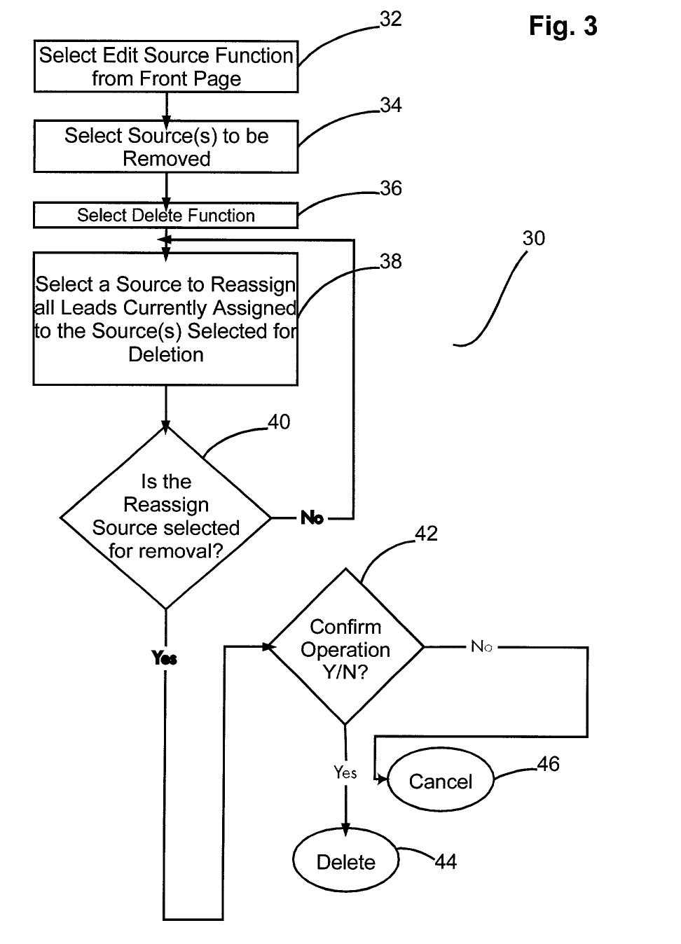

Each opportunity entered in the database system has a workflow for defining the duration and action to be taken upon each lead in a particular station. As a lead is entered into the database by either an account user or an administrator, the source of the lead is identified. Each source is assigned a specific initial station for the leads from that source, i.e. each lead entering the system from a particular source is assigned a specific initial station. Once a source is defined in the system, it remains there until a user selects to remove the source from the system. FIG. 3 is a flow chart 30 illustrating the process for a user to remove a source from the system. From the front page of the system, the user selects the edit source function 32. A table showing all of the sources in the system is provided to the user. The user selects each source that the user wants to remove from the system 34. Thereafter, the user selects a delete function 36, followed by a selection to replace the source selected from removal with a different source in the system 38. This step 38 ensures that each lead in the system identified with the source selected for removal will continue to be identified with a source. If the replacement source is a new source not yet entered in the system, the user must first create the new source within the system and then return to the process for removing a source.

The exercise of removing a source does not remove a lead. The process of reassigning leads to a different source ensures that each of the leads in the system is assigned to a source within the system. As shown in FIG. 3, the system queries the user at 40 to ensure that the source selected for removal has been reassigned. Before the source is actually removed, the user is presented with a request to confirm the operation 42 which prompts the user to confirm 44 or cancel 46 removal of the source from the system. Accordingly, the user has the authority to remove sources from the system without removing the leads that originated from or that are assigned to that source.

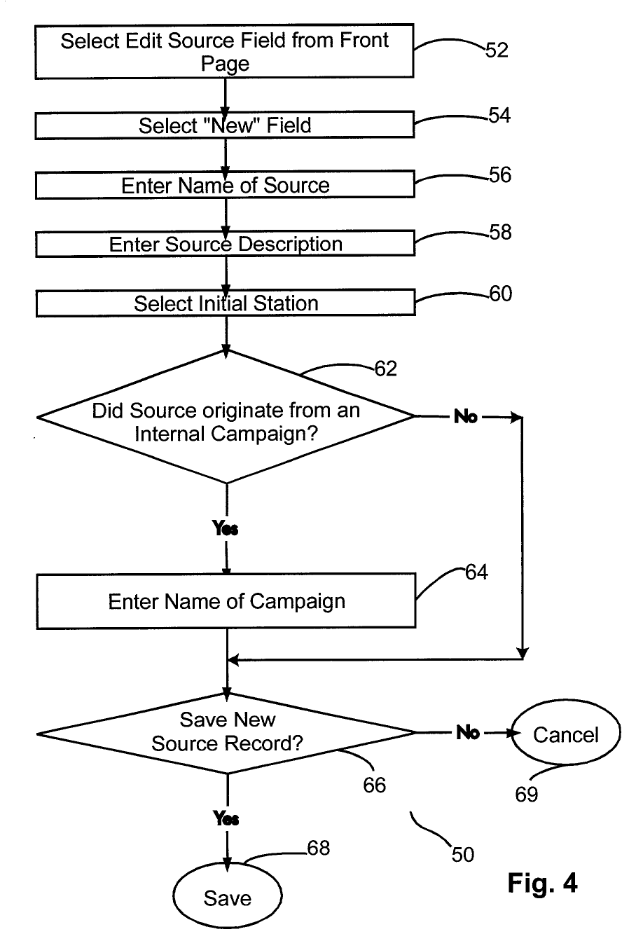

As noted above, an administrator and/or a user can create a new source in the system. FIG. 4 is a flow chart 50 illustrating the process of adding a new source to the system. From the front page of the system, the user selects the edit source field 52. A table showing all of the sources in the system is presented to the user. The user selects the new field 54. The user is then presented with several fields for entry of data. The user must enter a name for the source 56, a description of the source 58, and an initial station for leads assigned to the source 60. Each lead in the system is classified into an initial station in the workflow according to the source designation of initial station for leads assigned to that source. Alternatively, the administrator and/or user can designate each source to enter the workflow in one of several stations. When a lead enters the system and a source is designated, the user and/or administrator can select an originating station from the selection of stations designated when the source was created. Finally, if the source is internal 62, the user should indicate from which opportunity the source originated 64. Following entry of data in each of the appropriate fields, the user must select to either save or cancel the addition of the new source to the system 66. Upon selecting to save the source information, the user is presented with a request to confirm the operation prompting the user to confirm 68 or cancel 69 the addition of the new source to the system. Accordingly, both the administrator and user have the authority to add new sources to the system.

Once the system has an established workflow designated, either as a default or by an administrator's configuration of the system, the optimal opportunity to enter leads into the database and to allow the workflow to assist in management of the leads presents itself. It is important to appreciate that leads may originate from a number of sources and users of the system which may not be restricted to administrators alone. However, although many users can enter leads into the database, only an administrator can review the database for duplicate records or leads and act upon such duplication.

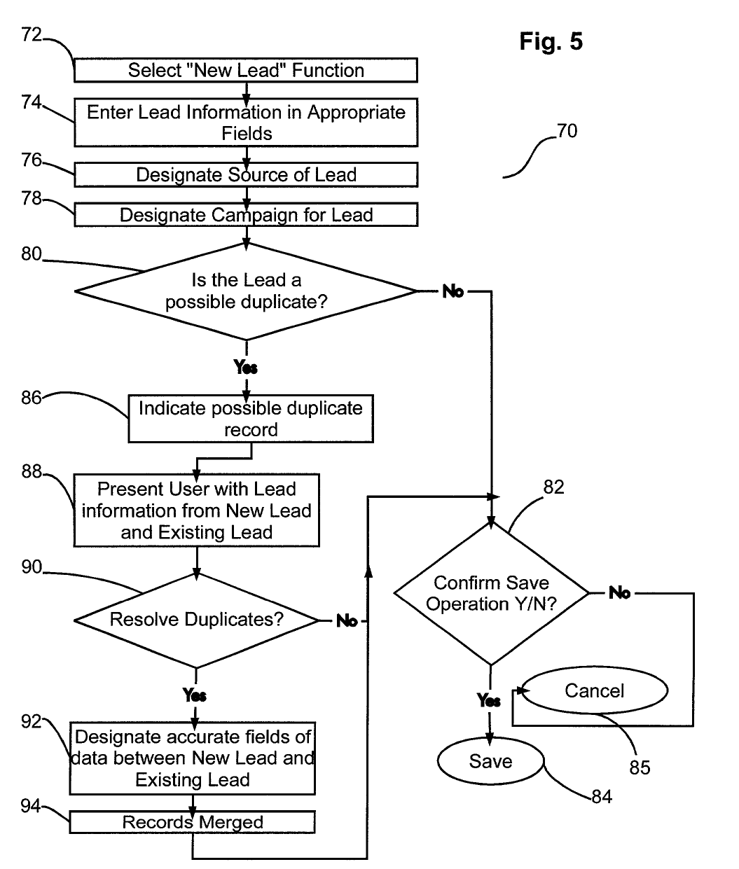

One of the most critical components of the system is the options available for entering lead records or creating lead records in the database. To create new lead records, the administrator or user must select the new choice function from the main page. FIG. 5 is a flowchart 70 illustrating the steps involved in creating a new lead record in the database. The first step is for the user to select a new lead function 72 from the front page of the system. The system will then present the input fields for entering a lead. The display will include the established fields for creating a record for the new lead. The user must manually enter the lead name into the name field, i.e. first name, last name, and middle initial, and thereafter enter contact information into the appropriate fields 74. Contact information may include the company name and division and the lead's position within their company.

The system also provides the ability for a user to select an existing company or division within a company from a list of companies/divisions already in the system. If the user selects an existing company and/or division within an existing company, the specific information for the company and/or division will populate those fields in the display. However, if the user manually enters the company data into the fields and this company/division is not in the database records, the user must save the company data as a new company and/or division. This task is performed by the user selecting a “save new company” function. Alternatively, if the user enters a combination of a company name and division name that is already in the database, the user is presented with a display that allows the user to then edit the company/division information to reflect the current information. The user may then select to save any amended data which would then be utilized when that company contact information is displayed. At this point the user will be returned to the previous lead entry display with all of the appropriate fields populated. Alternatively, prior to saving any changes to the company/division records, the user may select a cancel function, in which event the system will present the user with fields for manually entering a new lead with the information that was entered. The company/division list is then updated at this point with any newly added company/division data. Accordingly, upon manually entering lead information into the database, the user may select from a list of available companies and/or divisions within a company from existing records in the database or enter a new company/division record for the lead.

In addition to the company/division information and the lead data, the user must designate the source of the lead 76. Each source is associated with an initial station, as programmed and configured by the administrator. By selecting the source, the user will automatically designate the initial station in which the lead will enter the system based upon the system's established parameters that dictate that all leads from a specific source are sent to the source's specified initial station.

Finally, the user must designate an opportunity for the lead record 78. Each workflow in the database is based upon an opportunity which defines the workflow parameters for all leads within the opportunity. Therefore, each lead must be assigned to a specific opportunity to be active in the system. Leads may also be assigned to multiple opportunities simultaneously. As all opportunities are programmed and configured by the administrators, the user merely designates the appropriate opportunity 78 for the lead from a list of available opportunities. Accordingly, the parameters for managing each new lead entered into the database are designated by the selection of the lead's originating source which sets the starting station for the lead as well as the assignment of the lead to specified opportunity(s) which defines the lead's workflow though the system.

Upon entering new leads into the database there are two scenarios that can occur, either the lead is a duplicate of a lead already entered into the database, or the lead is a new lead and no prior record for this lead is present in the database 80. In the event the lead is not a duplicate record, the user need only select to save the record 82, 84, or to cancel entry of the lead 85. The lead is marked as accepted by the system and it is saved into the database and assigned to each designated opportunity. The user's display is then reset back to the display for entering new records into the database.

As discussed below within the section for administrator privileges, an administrator may search the entire database to determine potential duplicate records and resolve any such duplication scenarios. Although general account users do not have access to this maintenance feature of the system, general users are provided with information regarding potential duplication of lead records at the time that a new lead is being entered into the system. General account users only see names of leads that appear to be duplicates within those leads currently assigned to the user. Similarly, a Station Master who does not have administrator privileges will be restricted to viewing duplicate records within those leads assigned to the Station Master or leads in a station where the user is the Station Master. If a lead is a potential duplicate of a lead previously entered into the database, when the user selects to save the record into the database the lead will not be automatically accepted. The process for an administrator to resolve a potential duplicate lead upon manually entering a lead into the database is shown in FIG. 5. The administrator will then be presented with a message 86 indicating that the lead entry is a potential duplicate of an existing lead in the database. The administrator will then be presented with a display for manually entering a lead into the system with a replica of the information from the previous lead entry display 88 that resulted in the potential duplication scenario. However, the save function is now replaced with two options: to save and accept the new lead record or to resolve duplicate records 90. The administrator can then select from either of these two options. If the administrator elects to save the lead data and override the system's designation of the record as a potential duplicate, the administrator must select to save the accept the record 82. The record is then saved into the database and the administrator is returned to the front welcoming page of the system. However, if the administrator selects to resolve the duplicate lead record, the system then displays the new lead record data and the record data from the existing lead that was designated as the source of a potential duplication. The administrator then designates accurate fields of data between the two records 92, the records are merged 94, and the user selects a save function to record the operation. If the selected information is the record already entered and saved in the database, that record is updated and the new record is not saved to the system. However, if the selected information corresponds to the new lead data, a new record is inserted into the database and the original record is then removed from the database. At any time in this process the administrator may select to cancel their actions, in which case there is no new lead record created.

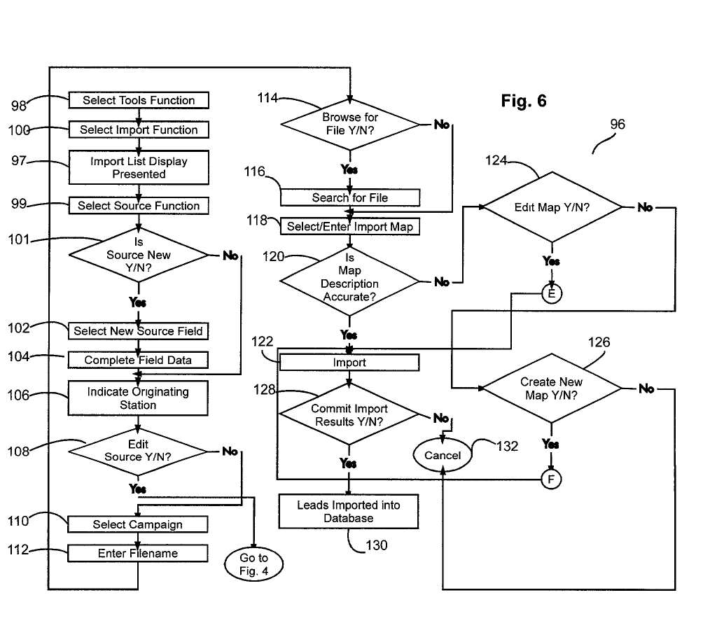

In addition to manually entering leads into the database, leads may be imported from existing lists or other external sources. This import function allows bulk transfers of leads into the database. The user selects a source file for the lead information and uploads the file to the database. However, prior to uploading the file, the user must create an import map that designates which field numbers in the import file match the attributes of the new lead(s). The creation of the import map is critical as it functions to direct specific data fields within the import source to the mapped corresponding fields of the system. For example, the import map would designate that the contact name field of leads in the import source should be imported into each new lead's contact name field within each record to be created. The system would then take the a new lead's contact name field from the import source and transfer the information to the contact name field in a lead record. The import map may and likely will also map other fields in the import source to designated fields in the lead record within the system and allow the system to automatically transfer the information from the import source to the system and create new lead records. FIG. 6 is a flow chart 96 illustrating the process of importing leads from an external source into the database. In the front page of the system, the user selects the tools function 98 and from there selects the import function 100. An import list page is loaded onto the user's display 97. The first step in importing a list is to designate a source from which the list arrived to the user 99 and thereby designate the source that will be associated with each lead record created through this particular import procedure. The user is then queried as to the status of the source 101. If the source is a new source, the user selects the new source field 102 and completes the field data 104 including designating the origins of the source 106, source description and originating station, similar to the process described above for creating a new source when manually creating new leads. In addition, the user also has the option of editing source information from the edit source field 108. This enables the user to amend the source information at the time of importing an external list. Once the user has selected the source of the list, the initial station for each lead in the list will be indicated on the display and shown to the user. If the user believes the initial station selection is inappropriate, then the user must select to edit the source at 108. Accordingly, the process of importing a list requires the user to designate the source of the list, and also allows the user to amend the source field if it is deemed inappropriate or inaccurate.

Following designation of the source and the originating station, the user must select the opportunity for the leads in the import list 110. As indicated above, the system has a workflow through which all leads are processed. The workflow may contain multiple opportunities in which leads can be processed. Therefore, as with manual entry of a new lead, the leads from an import list may be placed into a single opportunity or into multiple opportunities, as deemed appropriate by the user performing the import. Once the opportunity designations have been selected, the user is ready to import the external list. The user must enter the file name designated for importing the data 112. If the user is not sure of the exact name or location of the file 114, the user may select to browse the different disk drives of the system to find the file 116. Following selection of the appropriate file, the user must select an import map 118. The user may select an existing map or create a new map. Upon selecting an existing map, the user will be shown a description of the selected map. The user must then determine if the map description is accurate 120 for the import. If the map description is accurate and matches with the selected map, then the user may select to import the file 122. Otherwise, the user may select to either edit the existing map 124 or to create a new map 126. By selecting to import the file 122, the user is queried 128 as to whether they will commit the import results to the system. To complete the commitment, the user must confirm the query 128 at 130 or select to cancel the commitment at 132. Accordingly, the user may select from a variety of options to ensure that the information from the import source is properly directed to the fields in each new lead record to be created.

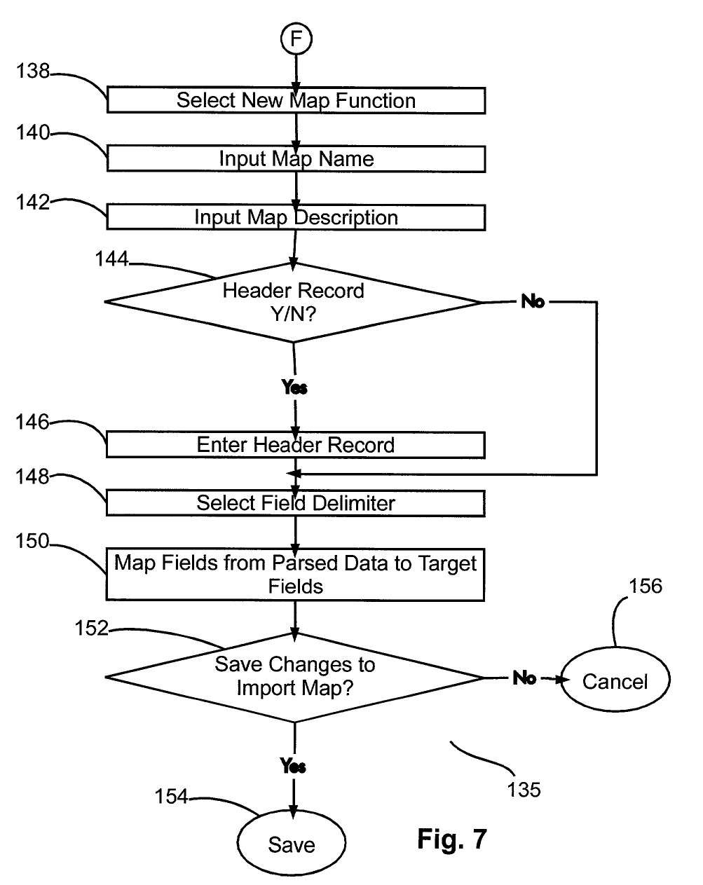

As mentioned above, the user may create a new map for importing data into the system. FIG. 7 is a flowchart 135 illustrating the process for a user creating a new map for importing data from an external source. If the user selects to create a new map, the user must select the new map function 138 from the import list display. The user will be presented with a new display with a map name field and a description field that are both empty. The user must input a name for the new map being created 140 and a map description 142 in the appropriate fields. The user then selects whether or not the import file contains a header record 144 and if so, enters the header record 146 in the appropriately marked field. Next, the user selects the field delimiter 148. As soon as the field delimiter is set, the first record(s) of the source are parsed, and a table is populated with the parsed data to determine the specific fields that exist in the source. The user then maps fields from the parsed data 150 of the source to the database fields in the system. If the user selects to include data field(s) from the import source that do not logically map to a field in the database, i.e. notes, suggestions, or comment field in the source records, the user can include the extraneous data in a comments field provided with each lead record in the system. During the mapping process, multiple fields from the import file can be combined into a single field in the database by inputting the field numbers and separating the field numbers with a comma or other separator character. However, the order in which the field numbers are placed in the map is indicative of the order in which the field data will be converted to the database. Upon completion of the mapping process, the user can select to save the map created 152, 154 to the database, or to cancel the mapping 156 process. Accordingly, if an existing map in the database is deemed inaccurate for a file import, the user can create a new map for use in the import procedure as well as save the map in the database for future file imports.

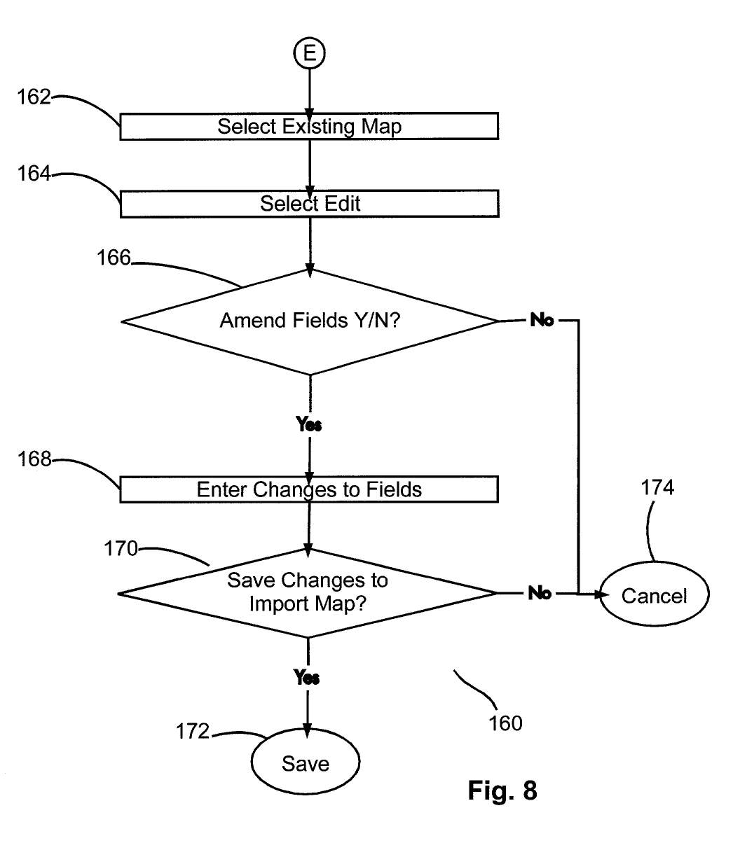

In addition to creating new maps, there are situations in which a user may select to edit an existing map. For example, this may occur if an existing source for import lists has modified their data format or map. FIG. 8 is a flow chart 160 illustrating the process for a user to edit an existing data import map. From the import list selection of the system, the user selects an existing map 162, and then selects an edit function 164. The user will then be presented with a display for editing import map data. All the fields of the map will be presented to the user complete with the information from the database of the selected import map. The user is not provided the option of amending the name of the file as this remains static. However, the user can make amendments to the mapping fields 166. By selecting to amend fields of the import map, the user may enter changes to any of the available fields 168. Thereafter, the user is queried as to whether they want to save changes made to the import map 170. The user may select to save the changes made to the map or to cancel the changes. The advantage of saving the changes 172 is that it prevents subsequent users from having to make the same or similar changes on future file imports. Once the user has saved the changes to the mapping, the database is updated with the changes to the import map. Following any changes to the import map, the user can select the import function which allows the source upload to the server to be parsed with the parameters outlined in the import map. Alternatively, the users can cancel the changes made to the import map 174 with out committing them to the system. This is advantageous when the changes are deemed inappropriate for the system.

Finally, following the import function the user is presented with an import summary subsequent to any file import which reports general information relating to that import. At a minimum, the import summary will report to the user the quantity of successfully imported leads and the quantity of bad records. In addition, data pertaining to the first ten successfully imported leads are displayed in a table in conjunction with a field that allows the user to complete the import of the lead or to cancel the import. Essentially, the table is a visual check on the import of the file prior to actually committing the imported data records to the database. The user must select to enter the import or to cancel the import 128. By selecting to commit the import 130 all the successfully imported records will be added to the database, and by selecting to cancel the import 132 the import ceases and none of the records are added to the database. If the user selects to commit the import, as each lead is added to the database the server checks the database and determines if any of the leads are possible duplicates of leads previously entered into the database. If there is a potential duplicate lead, the lead will be marked as an unaccepted lead and is placed in the “check duplicates” section of the database. Accordingly, the process of importing leads to the database provides several safety mechanisms for ensuring that the import procedure adequately imports the desired information in the desired format into the database server.

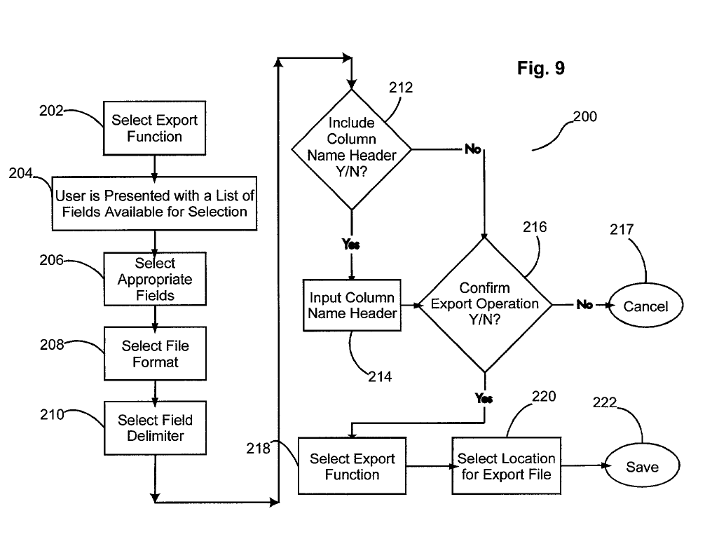

Just as users and administrators may be interested in entering and importing sources of leads into the database, there are situations in which the user and/or administrator may need to export lead records to external sources such as external database systems. FIG. 9 is a flow chart 200 illustrating the process of a user exporting copies of the lead records from the database. The user may select an export function 202 through conducting a search, resolving duplicate records, or if there are leads awaiting action from the user in a “my leads” icon or similar location. The user is presented with a list of field selections available for export from the database records 204. The field selection includes all fields in the database, including custom fields. For example, the user must select the fields that are to be exported to an external file 206 as the target of the export. The user may also have additional options as the export target as well. In addition, the user must select the file format for the export file 208, the field delimiter 210, and determine if the export file should contain a column name header 212. If the user selects to include a column header, they must input the column name header 214 in the appropriate field. Following each of these selections 212 for 214, the user must select to confirm export of the records with the selected field 216 or to cancel the operation 217. To proceed with the file export, the user selects the export function 218. The export file is generated and saved in a temporary location on the server. The user then selects a location to save the export file 220. The export file is then saved 222 to the user's selected location. Accordingly, the records of the database may be exported and saved in a source external to the database.

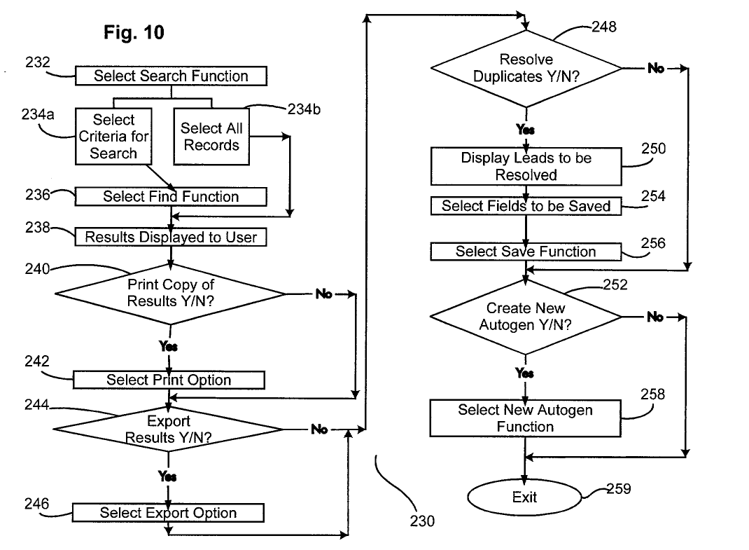

Following entry of lead records into the database, the leads are processed through the workflow. One of the tools available to a user account is the ability to search the database for specific lead records. FIG. 10 is a flow chart 230 illustrating the process of a user searching the records of the database. From the front page, the user selects the search function 232. Thereafter, the search display is loaded. The user is presented with a selection of fields including: last name, first name, company, opportunity, source, station, users, and date range for lead entries in the database, as well as any custom created fields. This list is merely an example of some of the field selections available to a user conducting a search and should not be considered a limiting list. The user may select criteria for the search 234a, and then select a find function 236. Results are then displayed to the user. If the user does not want to select a search by specific fields in the database, the user may search the database for all records 234b by selecting all of the records function. Results of the find function are then displayed to the user 238. Alternatively, the user may select to cancel the search, which results in the user's return to the front page of the program. Accordingly, the user may conduct the search by specified fields, or the user may conduct a general search of the records in the database.

Following the input of the search criteria, if any, the user is presented with the results of the search 238. Ideally, the users will be graphically presented with the results of the search. The user is then presented with several options for reviewing the search results, including: printing a copy of the results 240, exporting the results list 244, resolving duplicate records 248, and creating a new auto-generated report 252. If the user wants to print a copy of the search results, the user must select the print option 242 to view a hard copy of the search results. In addition, the user may select to export the search results to a file 246. If the user determines that there are or may be duplicate records in the search results, the user may select to resolve duplicate records 248. The user then selects the specific lead records they believe are duplicates of each other, and then selects a “resolve duplicates” function. The user will then be presented with the records of the selected leads that need to be resolved 250. The user may select the fields that should be saved for the record, and then select the save function 256. This results in the database being updated with the saved information, and the unselected fields and/or lead records are removed from the database. The lead record that was updated is marked as accepted. Finally, the user can select to create a new auto-generated report for the lead records in the search results by selecting the “new autogen” function 258 or an alternative icon, selection, or menu that may be available. Following each of the selections available, the user can exit the menu options at 259. Accordingly, the user has an array of options available when searching the lead records of the database.

In view of the fact that the system is designed to track and manage leads for various teams of individuals, it is critical that the system include the ability to generate reports to groups as well as specific individuals in need of such data. Reports may be generated based upon a variety of field in the records of the database. For example, it may be advantageous to review how leads are progressing based upon the source of the lead, review the leads in a particular station, or generate an aging report. In addition to preselected report generation, the user of the system also has the ability to custom generate reports based on the different fields in the records of the database. The ability of users to custom generate reports may be limited depending upon the level of privileges provided to specific users. For example, a user may be designated as a station master which may require that their report generating ability be greater than a standard user or a user may be designated as management or other special status which provides them with greater abilities as users than that of a typical account user. This should not be confused with the distinction between administrators and users as that distinction relates to the oversight of the database and opportunities, and is independent of the custom report generating feature in that account users can be assigned differing privileges with regard to custom report generating features irrespective of whether or not they have administrator privileges. Accordingly, a user of the system who has the proper authority within the system may generate reports to review the progress of lack thereof of lead in the database.

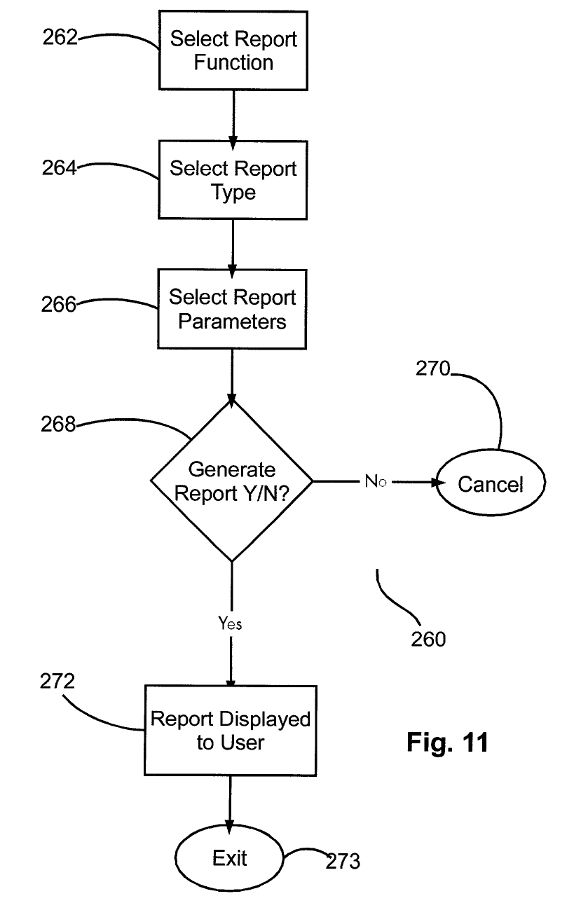

To generate or execute a report, the user selects the reports option on the front display of the program. FIG. 11 is a flowchart 260 illustrating the process of creating a statistical report on the workflow. The first option available to the user is to select the report function 262. This selection will present the user with a list of all available report types. Following the selection of the type of report 264, the user must select the report parameters 266. Such parameters may include row parameters and column parameters. An example of available parameters may include: a menu of opportunities in the workflow, a menu of stations in the workflow, a menu of originating sources for the lead records in the database, and a menu of assigned users in the workflow. This example of report parameters should not be limited to the list indicated above, as the reports parameters may be expanded by the fields of the database. Following selection of report parameters, the user may select to generate a report 268 if they would like to view a report based upon their selected parameters or the user may select to cancel compilation of a report 270. Upon selection of the option to generate a report, the user is presented with a report on the display 272. Together with the report, the user will have an option to print a hard copy of the report, setup a new autogen or to indicate that the user has completed reviewing the report results and return to the previous display. The report results are generated from a predefined query using parameters selected in the report generation selection. Following display of the report, the user may exit the display 273 and return to the main menu. Accordingly, the report compilation option enables a user to generate a custom report from a list of available fields in the database.

In addition to allowing the user authorization to request and generate reports from the database, the user may request for the database to automatically generate reports on a periodic basis and distribute the reports via electronic mail incorporating the reports or with hyperlinks to the reports in addition to other end formats which may be available for reports such as hard copy, facsimile, voice transmission, or other electronic formats. This electronic mail embodiment allows an authorized user to set up a schedule for the database to automatically generate and electronically distribute reports based upon the parameters selected. The user has the option of creating a new automatically generated report, viewing existing automatically generated reports, amending the parameters of an existing automatically generated reports, or removing an automatically generated report from the workflow.

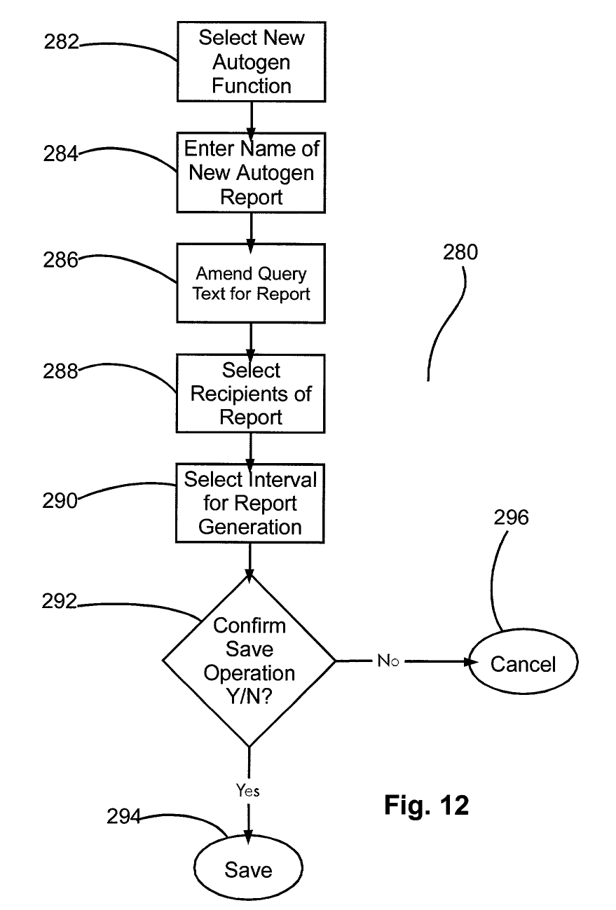

FIG. 12 is a flowchart 280 illustrating the process of creating a new automatically generated report. The user selects a function indicating the option of creating the new automatically generated report 282. This function is available following a search of the database, or following review of an existing report. The user's display is refreshed with a new information including fields for the new automatically generated report. The user must enter a name for the new report 284 in the appropriate field. The query text for the new report is provided and is based upon the query used in generating the result set from either the prior search or prior report generation. The user may amend the query field 286 to customize the automatically generated report according to the desired parameters. The user then selects the recipients who should receive the report 288 from a list of available users in the system. In addition, the user must select the interval in which this report will be mailed to the selected recipients 290. Finally, the user may select whether to send the report currently or to default to the time interval set. Following selection of each of the above noted options and fields, the user may either save or cancel the new automatically generated report 292. By selecting the save option 294, the parameters of the new automatically generated report are saved in the system, and by selecting the cancel option 296 the system returns to a previous page without saving the new autogen parameters. Accordingly, any user of the system has the authority to create a new automatically generated report and have the report delivered by way of various methods.

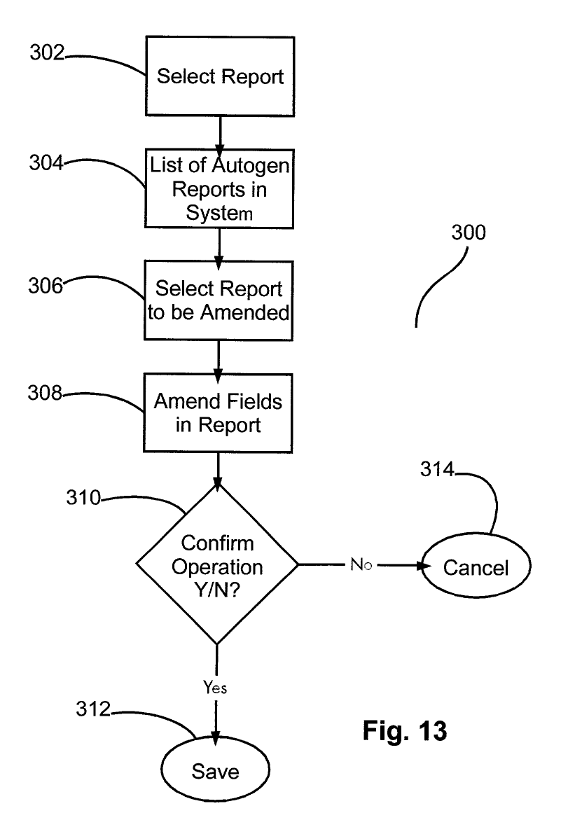

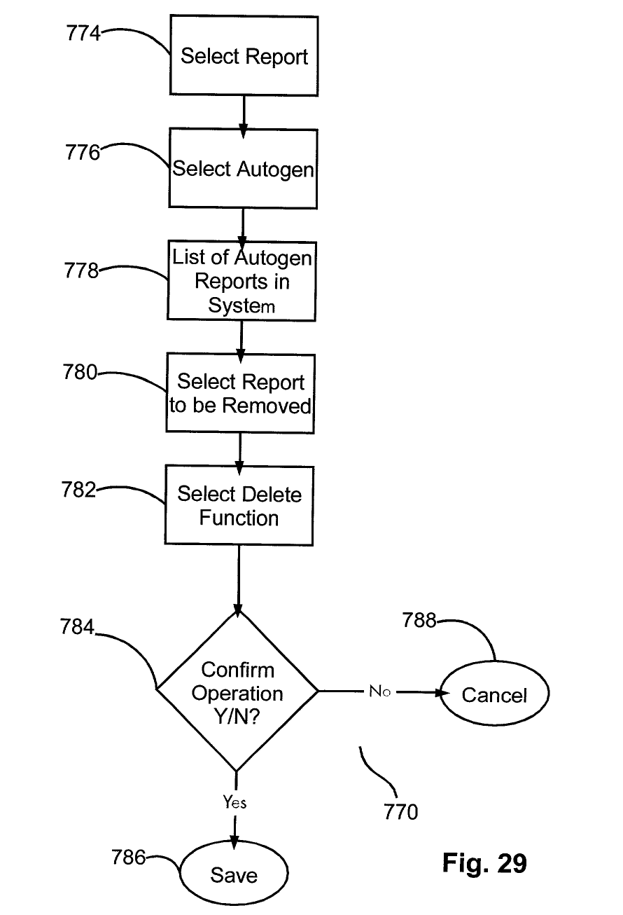

In addition to creating new automatically generated reports, the user can select to amend the parameters of an existing report, and an administrator can select to remove an existing report. FIG. 13 is a flow chart 300 illustrating the process of amending the parameters of an existing auto-generated report, and FIG. 29 is a flow chart 770 illustrating the process of removing an auto-generated report from the system. The user selects the report function option 302 from the report selection of the main menu. The user's display is refreshed with new information presenting a list of each of the automatically generated reports in the system 304. Each report listed will include the name of the report, the query associated with each report, an update interval, and a list of users who have been selected to receive the report. To amend any of the reports and their associated parameters, the user select the report to be amended 306, and the user's system then displays the information in a format similar to that shown to the user when creating a new report. Each of the fields of the report will contain the report's current information from the database. The user can select to amend the data in any of the fields 308 with the exception of the name of the report. Following amendments to any of the fields and the associated parameters, the user can select to save the changed field data 310 and 312 or to cancel the changes 314. By selecting the save command, the report is saved in the system with the new parameters as amended. Accordingly, a user of the system has the authority to amend the parameters of any automatically generated report in the system.

As with account users, administrators also have access to report generating options. However, administrators only an administrator is given the authority to delete existing reports as well. FIG. 29 is a flow chart 770 illustrating the process of removing an autogenerated report from the system. For users with administrative rights, upon selecting the automatically generated report option 776 from the report selection of the main menu 774, the administrator is presented with a list of each of the automatically generated reports in the system 778. To remove an automatically generated report from the system, the administrator must select that report 780, followed by a selection of a delete function 782. By selecting the delete function, the administrator will be prompted to confirm removal of the report 784. A positive response 786 to the confirmation 784 will result in the removal of the selected report from the system, and a negative response 788 to the confirmation 784 will result in the selected report remaining in the system. Accordingly, only an administrator has the authority to remove an automatically generated report from the system.

Administrator Privileges

In addition to all the functions available to account users, administrators also have access to a select set of functions that enable them to customize the workflow of the database. Included within this set of functions is the following: the ability to customize the workflow itself; add opportunities to the workflow; add, remove or change user accounts in the database, view a log file; add, remove or change custom fields; and edit system electronic messages. This list is merely demonstrative of several of the privileges associated with an administrator's account. The list may be expanded to include additional privileges in accordance with system parameters. A sample of an administrator front page is shown in FIG. 1. In general, the privileges of an administrator will overlap the privileges of an account user. If the user of the database chooses to assert their administrator rights and privileges, they need only select the administrator button 12. Otherwise, the administrator may select from the fields that overlap general privileges assigned to account users. A sampling of general user privileges also available to administrative users include inserting a new lead 14, editing information on an existing lead 16, searching the database 18, compiling reports 20, and accessing tools 22. More details for each of the fields 14, 16, 18, 20 and 22 are explained above in the general account user privileges section and are hereby incorporated by reference.

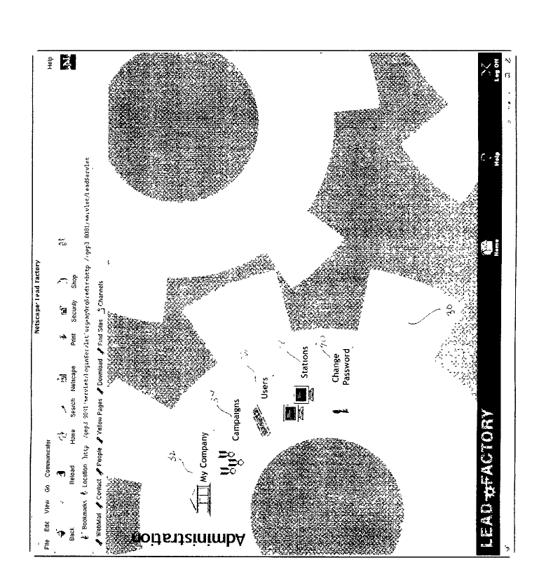

If the administrator selects the administration field 12, they will be presented with a fresh page with a new menu. FIG. 2 is an illustration of the administration page 30. A sampling of administration privileges includes amending company identifying information 32, amending opportunity definitions and protocols 34, amending user accounts 36, amending station definitions and protocols 38, and changing passwords 40. Each of these selections 32, 34, 36, 38 and 40 allows the administrator to alter the identity and course of action for an opportunity and the leads maintained therein.

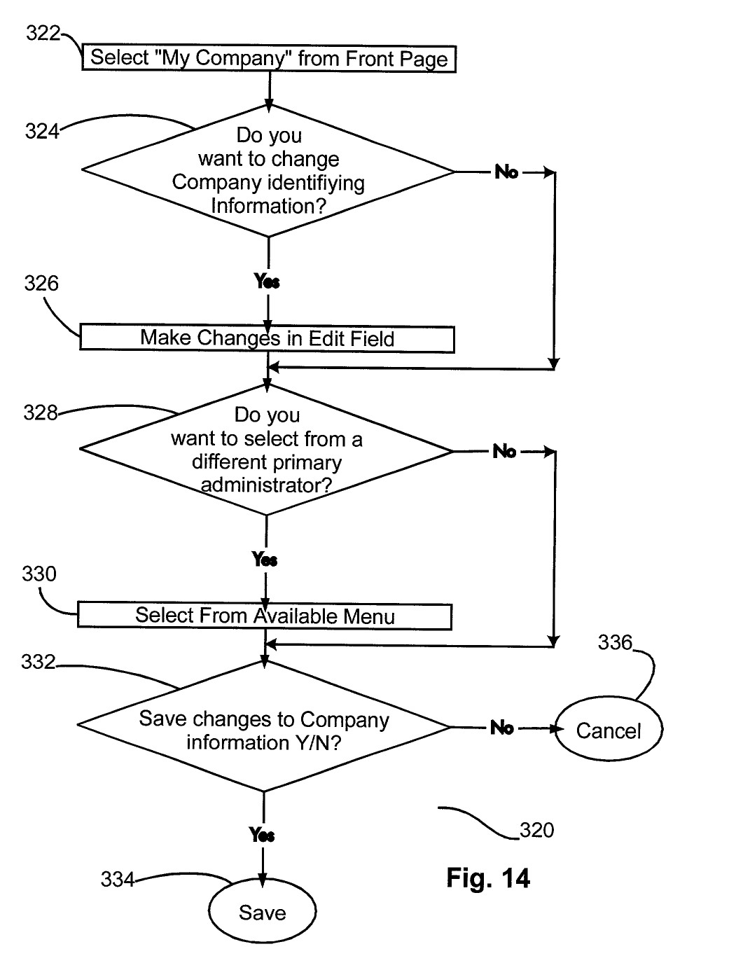

FIG. 14 is a flow chart 320 illustrating the processing of amending company identifying information. Upon selecting the “my company” choice 32 from the administrator's front page 322, the administrator must determine if they want to change company identifying information 324. If the administrator elects to make changes to the company identifying information, the changes must be made in an edit field presented to the user 326. In addition, the administrator can determine if they want to select a new primary administrator for the company 328. If the administrator selects to assign a new primary administrator, they must make the selection from an available menu 330. Upon either selection 324 or 328, the administrator must select to save the changes 332, 334 or to cancel the changes 336. Accordingly, only an administrator can amend company information and/or reassign a primary administrator for the company account.

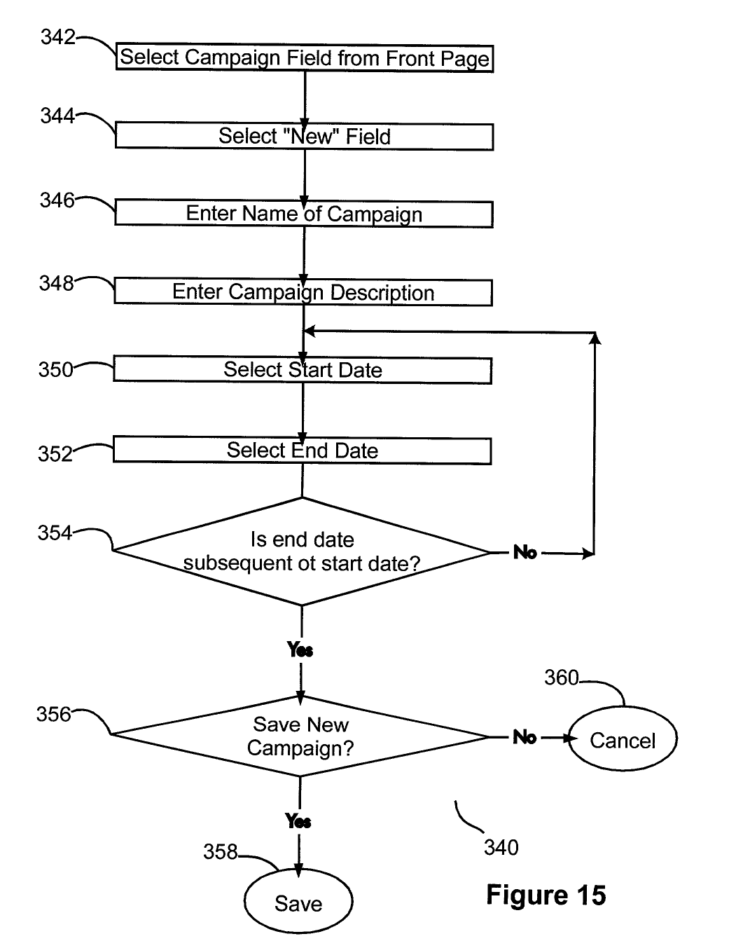

An opportunity is an effort organized around a single product or promotion, and represents the context in which a user might contact a lead categorized in a specific opportunity. A lead entered into the database may be categorized into more than one opportunity at any given time. This lead can then show up in different stations and be controlled by different users of different opportunities. The opportunity field 34 outlines the current opportunities available in the database. The administrator may select to create a new opportunity, edit a current opportunity, or remove a current opportunity. FIG. 15 is a flowchart 340 illustrating the steps an administrator progresses through when creating a new opportunity. The administrator selects the opportunity function from the front page 342 followed by selection of the new field 344. Thereafter the administrator enters the name of the opportunity 346 and the description of the opportunity 348 in the appropriately marked fields. In addition, the administrator selects the start date 350 and end date 352 of the opportunity. The end date of the opportunity must be subsequent to the start date 354. If the administrator enters the end date to be prior to the start date, the system will indicate an error and prompt the administrator for an end date that is subsequent to the start date. Following the entry of the start and end dates of the opportunity, the user must determine if they want to save the opportunity identification data entered 356. If the administrator wants to save the opportunity, they must select the save field 358, which saves the new opportunity information in the database. Subsequently, the view/edit page is loaded onto the screen with the saved opportunity data. However, if at 356 the administrator chooses not to save the new opportunity data, the administrator selects the cancel field 360, and the administrator is once again presented with the administration page of FIG. 2. When creating an opportunity, the administrator will be provided with a description field which allows the administrator to provide a descriptive phrase identifying the specific opportunity. Both the start and end dates for the opportunity may then be entered. Finally, the administrator must elect to either save the opportunity information and thereby initiate a new opportunity in the database or cancel the operation to remove any new opportunity information entered and abort the procedure. Accordingly, the administrator has the authority to initiate an opportunity by entering new opportunity data and saving this data in the database.

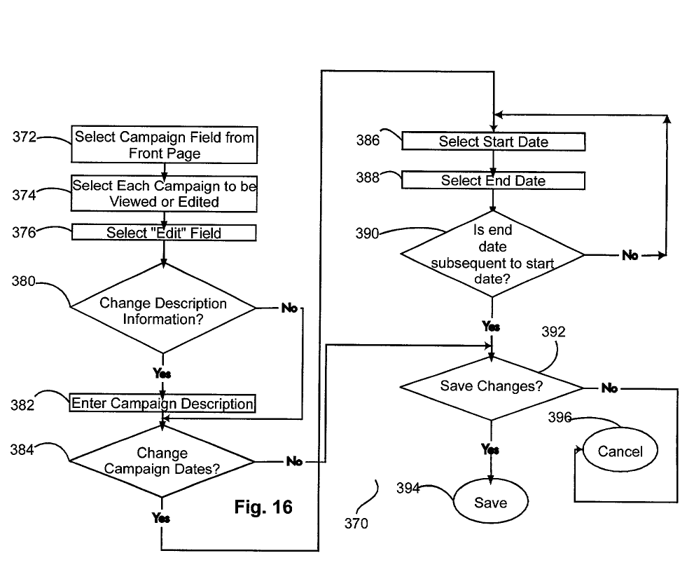

Once an opportunity has been initiated, an administrator has the authority to edit opportunity information. FIG. 16 is a flow chart 370 illustrating the process of editing an existing opportunity. The administrator selects the opportunity field from the front page of the administrator options 372. Thereafter, the administrator is presented with a list of each of the active opportunities in the system. Each opportunity listed will include the name of the opportunity, a description of the opportunity, and the start and end dates for the opportunity. The administrator selects each opportunity to be edited by selecting that field 374. Following the selection of the opportunity, the administrator may select to edit the opportunity parameters 376. The administrator is then presented with a page similar to the page for creating a new opportunity. However, each of the fields is complete with the opportunity's current data. The administrator is given the option of changing the description of the opportunity 380 and the start and end dates for the opportunity 384. If the administrator selects to amend the description of the opportunity, the administrator must enter a new opportunity description 382 in the appropriate field and make any necessary changes by the use of a keyboard, pointing tool, and/or other input device.

In addition, the administrator may alter the start date 386 and end date 388 of the opportunity through the edit opportunity function. As mentioned above, if the administrator enters the end date to be prior to the start date, the system will indicate an error and prompt the administrator for an end date subsequent to the start date 390. Before exiting the opportunity edit page, the administrator must indicate if the administrator's changes to the opportunity should be saved 392 to the database. By selecting to save changes to the opportunity, the user will be prompted to confirm the operation 394 or to cancel the changes made to the selected opportunity 396. The act of canceling the current operation retains the prior opportunity settings. Accordingly, the administrator may elect to edit the name and start and end dates of each ongoing opportunity during the opportunity.

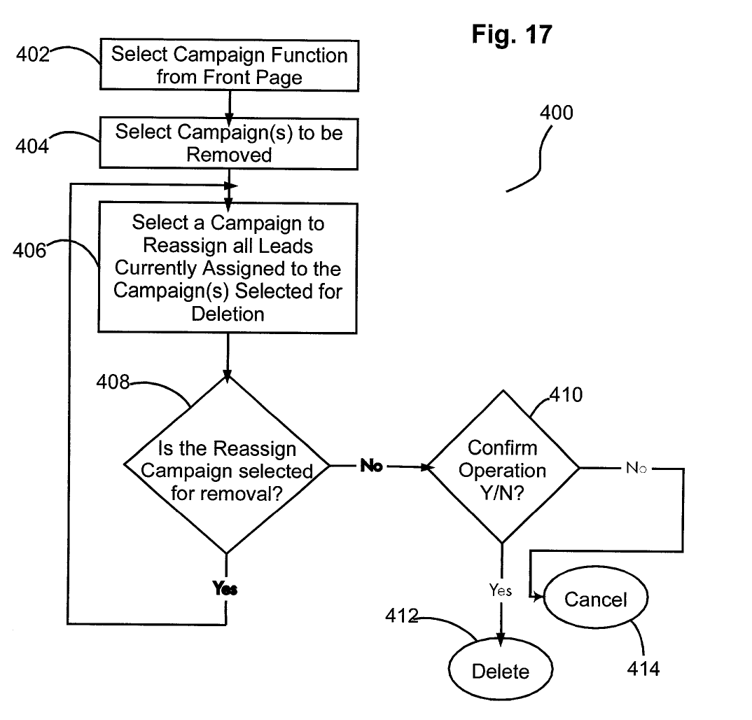

In addition to creating new opportunities and editing existing opportunities, an administrator may remove an existing opportunity from the database. FIG. 17 is a flow chart 400 illustrating the process of removing an existing opportunity from the database. The administrator selects the opportunity field from the front page of the administrator options 402. Thereafter, the administrator is presented with a list of each of the active opportunities in the system. Each opportunity listed will include the name of the opportunity, a description of the opportunity, and the start and end dates of the opportunity. The administrator selects the name of the opportunity to be removed 404. Following the selection of the opportunity, the administrator must select to reassign all leads from the opportunity selected for removal to a different opportunity 406. If the administrator selects the opportunity reassignment to be the same opportunity that has been selected for removal 408, then the administrator will be prompted to return to 406 to select an opportunity for reassignment of all leads from the opportunity selected for removal. Following steps 406 and 408, the administrator will be presented with a request by the system to confirm the delete operation and again prompted as to whether they would like to remove the selected opportunity 410. If the answer to the final query 410 is positive, the selected opportunity is removed from the database 412 and all leads are reassigned from the deleted opportunity to the selected alternative opportunity. Otherwise, the selection is canceled 414 and the selected opportunity is not removed from the system. Accordingly, the administrator has the option of removing an existing opportunity from the database in order to efficiently manage ongoing and subsequent opportunities.

The administrator has many rights and responsibilities in establishing and managing accounts. The administrator can set up and remove users from the database, and can also assign administrative responsibilities and privileges to specific users of the database. By selecting the user field 36 from the administrator page 30, the administrator is provided with a listing of all established users in the database. A user of the specific account is a person who works with managing leads through an opportunity in the account. From this point, the administrator may select to add new users, remove existing users, reassign leads from one user to a different user, or edit existing user information from or within the database. Accordingly, the administrator has all the rights and privileges associated with managing users of the database.

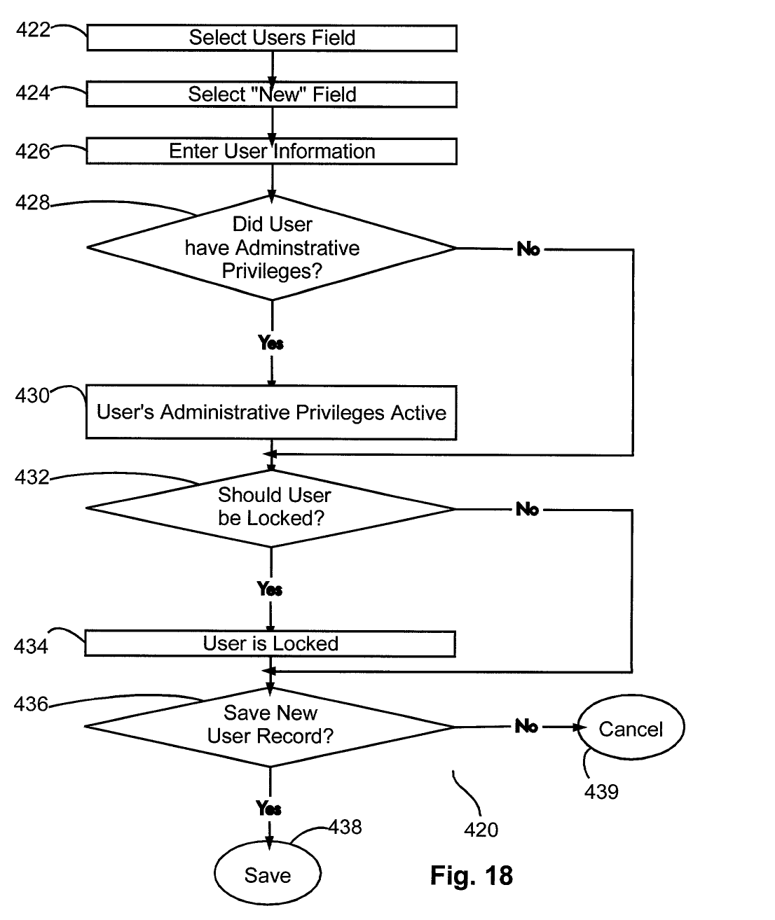

FIG. 18 is a flow chart 420 illustrating the process of adding user accounts from the system. From the administrator front page of the system, the administrator selects the users field 422. The administrator is then presented with a listing of all the user accounts in the system. If the administrator wants to add a new user account, the administrator selects the new field 424. The administrator will then be presented with fields for identifying the user. For example, the user field information may include the following data: first name, last name, password, telephone number, and email address. This listing may be changed to include other identifying information that may be important for identifying user accounts. The administrator enters information into each of the fields presented 426. Thereafter, the administrator must select if the new user account will have administrator privileges 428 and if so activate administrative privileges 430. Thereafter, the administrator must determine if the user account should be locked 432, and if so, lock the account 434. Following selection of these two options 428 and 432, the administrator must elect to either save or cancel the operation of adding the new user to the system 436. Upon selecting to save the user account information, the administrator is presented with a request to confirm the operation which prompts the administrator to confirm 438 or cancel 439 the addition of the new source to the system. Accordingly, the administrator has the authority to add new user accounts to the system.

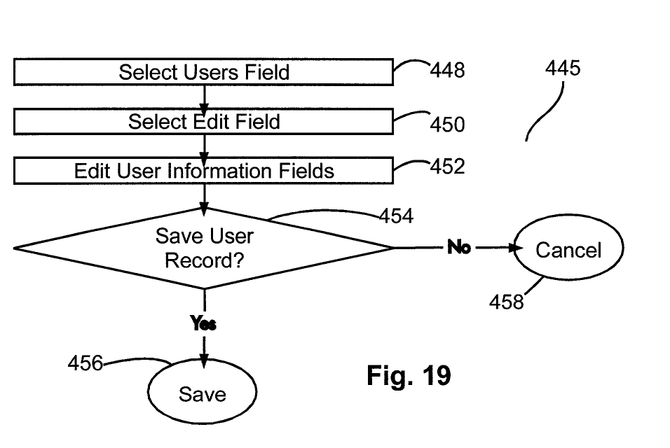

As mentioned above, the administrator also has the ability to edit user account information for any and all users of the database. FIG. 19 is a flow chart 445 illustrating the procedure for editing a user account. The administrator selects the users field from the front page of the administrator page 448. The administrator is then presented with a listing of all the user accounts in the system. The system also may display the pertinent information associated with each user account. To edit a specific user, the administrator selects the appropriate field 450. The administrator is then presented with fields similar to that presented when creating a new user account. The administrator may enter any of the fields and change the user information 452 with the exception of the username. Following the input of changes to any of the fields, the administrator may select to either save or cancel the changes to the user account 454. Upon selecting to save the user account information, the administrator is presented with a request to confirm the operation which prompts the administrator to confirm 456 or cancel 458 the edit operation and all new changes to the user information. Once the administrator makes their selection, the administrator is once again presented with a listing of all users of the database with the current information in the appropriate fields. If the administrator elected to save changes to a user account, the listing will include the updated information, however, if the administrator elected to cancel the operation, the listing include the prior information without any changes to the list. Accordingly, the administrator has the authority to edit user accounts.

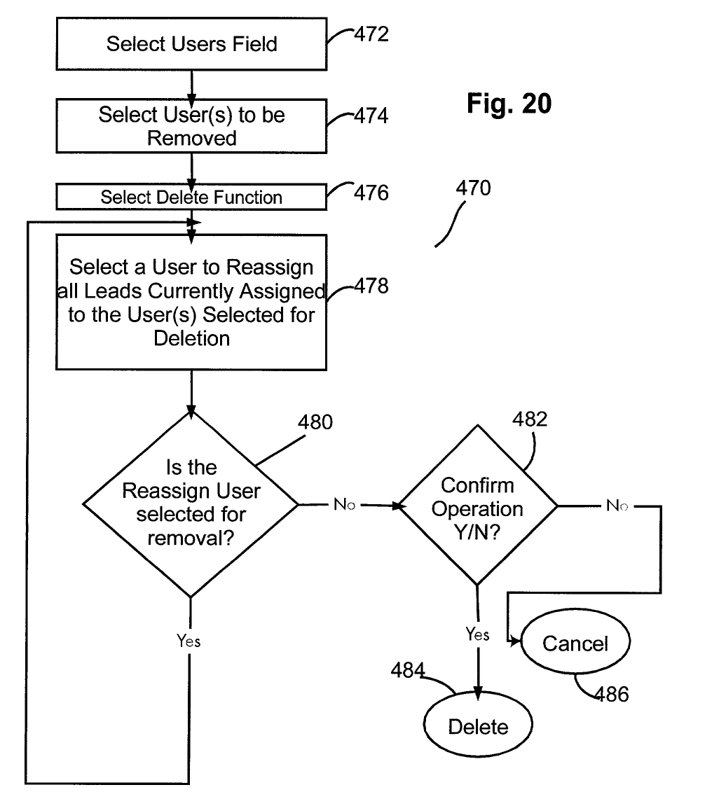

In addition to adding user accounts and editing user accounts, the administrator also may remove user accounts from the database. FIG. 20 is a flow chart 470 illustrating the process of removing or deleting user accounts from the database. The administrator selects the users field 472 from the front page of the administrator page. The administrator is then presented with a listing of all of user accounts in the system. The system also may display the pertinent information associated with each user account. To remove a specific user, the administrator selects the appropriate field 474 for that user account followed by a delete function 476. Subsequently, the administrator must select an existing valid user account to whom all of the leads of the user account selected for deletion will be assigned 478. If the user account for reassignment of leads is the same as the user account selected for removal 480, then the administrator will be requested to reassign the leads to an alternative user account that is currently active within the database. An active user account cannot be removed until all leads assigned to the user account have been reassigned to another user account. Following the selection of an appropriate user for reassignment of leads, the administrator selects the done field. The administrator is then prompted to confirm the removal of the user from the database 482. Confirmation 484 of the removal of the user will remove the user from the database. Alternatively, the user can cancel 486 the removal function.

Each lead in the system is placed in a station which defines the status of the lead as well as the action required on the lead in order to move the lead through the workflow system. In general, leads move from one station to another eventually ending up as either a sale or as a rejected contact. Each station in the system is defined by paths directing leads into the station and out of the station, as well as setting a duration in which a lead may remain in any one station. As discussed above, if a lead exceeds their duration in a particular station, messages and/or alerts are generated and sent to predefined individuals requesting that action be initiated on the lead. The messaging and alert system acts as a fail safe for ensuring that leads do not remain idle in the system for a greater period of time than is optimal given a lead's characteristics as defined within the system operating parameters. Furthermore, the work flows ensure that the users of the system receive notification at periodic intervals to maintain the opportunity within the time line programmed into the system and each predefined station. However, it should be noted that the duration of a station may be modified to adapt the system to a specific opportunity need and can thereby be customized to maximize the success of a given opportunity by individualizing the opportunity parameters.

As defined above, a station is a predefined location within the system in which a lead may reside as a component of a workflow scenario. The database is pre-configured with a default workflow consisting of thirteen stations. However, administrators of the system may customize the system with additional or fewer stations as needed and as individual opportunities may require. Each lead enters the workflow of an opportunity in a station and is processed through the workflow by the users assigned to manage the leads in each station. Based upon feedback or lack of feedback from a lead in an opportunity or the progress of the opportunity, a lead will progress through the workflow to a subsequent station until such time as they progress to a sales contact, are redirected through the workflow, or exit the workflow. Accordingly, it is important to be able to modify the workflow according to the needs of entities utilizing the system and be able to customize the configuration of the system to meet the individual needs of the entities utilizing the system as well as the individual circumstances surrounding a specific opportunity.

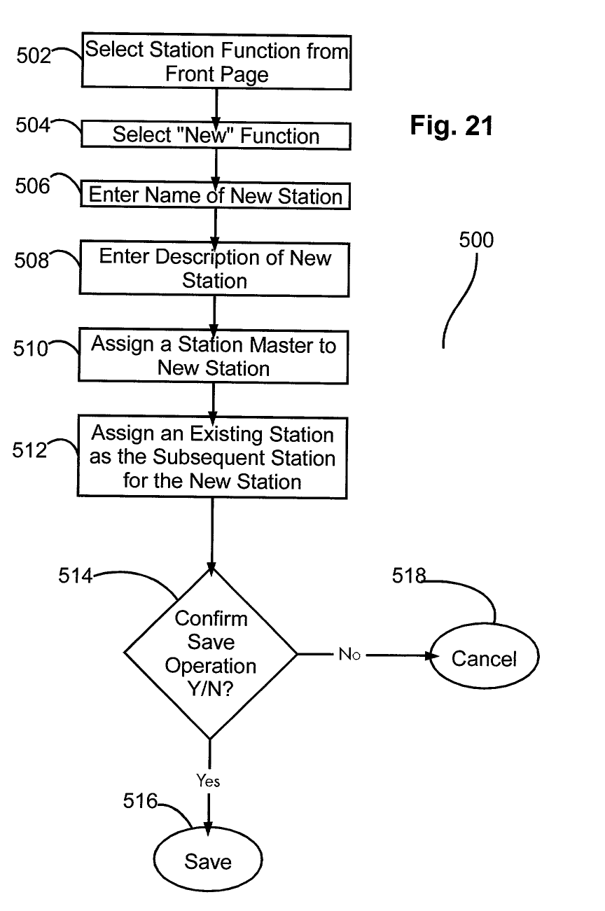

Upon selecting the stations field 38 in FIG. 2, the administrator has the option of adding a new station, viewing and/or editing the parameters an existing station, adding a new action to an existing station, and/or amending a station action. FIG. 21 is a flow chart 500 illustrating the process of creating a new station. Following selection of the stations function from the front page 502, the administrator may select to create a new station 504. The administrator then enters a name for the new station 506, and thereafter enters a description for the new station 508. Following the name and description, the administrator must assign a station master 510 to oversee management of the user(s) assigned to the new station. The administrator may select the station master from a menu of available users. Each station in the workflow processes leads from a previous station to a subsequent station, or removal from the database. Therefore, the administrator must select an appropriate subsequent station 512 or a list of appropriate subsequent stations from which a user may select to assign the leads being processed through the system. This is a critical step in creating stations in the workflow and providing for a proper transition of leads through the system. In order to effectively market to the leads in the database, it is important that the leads are assigned to subsequent stations in accordance with the strategy of the administrator or the administrator's company and the parameters of the opportunity. Following creation of the new station, the administrator may either selection to save the new station or cancel the creation of the new station. The administrator is then prompted to confirm the operation 514. Upon confirmation 516, the new station is added to the workflow. If the administrator selects to cancel the function 518, the administrator will be returned to the main menu. Accordingly, creating new stations allows administrators the freedom to design their own unique workflow rules and customize the system to meet varying needs of those utilizing the system.

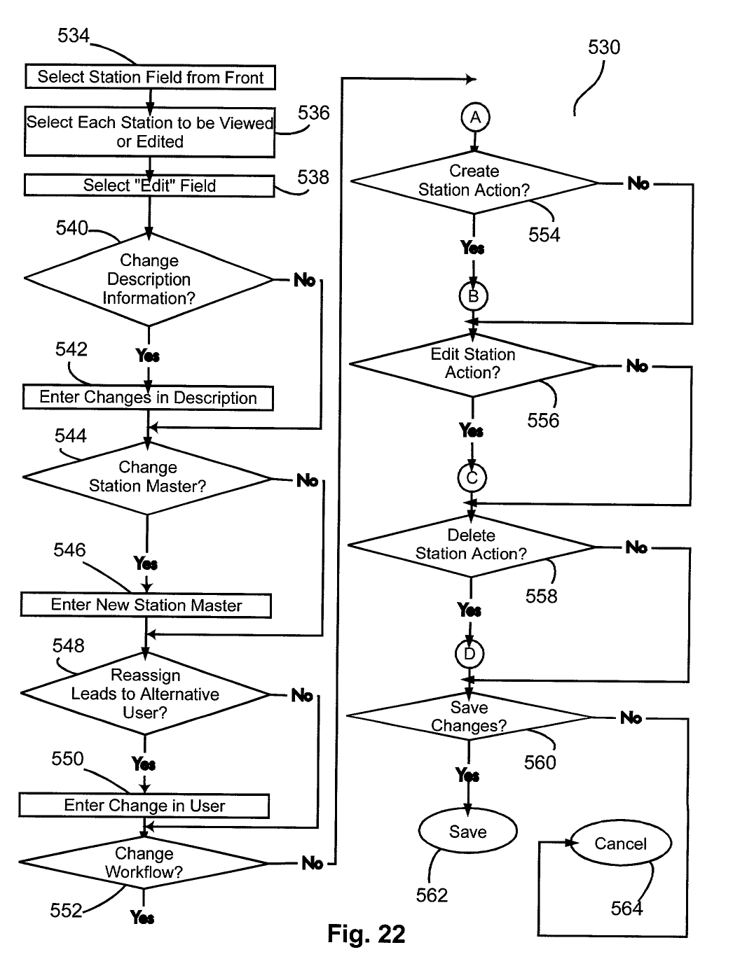

As discussed above, the database may be designed with an existing workflow, wherein there are a set quantity of stations, with each station defining allowable transfer of leads. Alternatively, the workflow can be customized with alternative stations and station actions. In either scenario, the administrator may decide that they would like to edit the parameters of an existing station. Similar to adding a new station, an administrator may also view the definition of a station or edit a station and it's associated defining characteristics. FIG. 22 is a flow chart 530 for viewing and/or editing an existing station. The administrator must select the station field from the front page 534. The administrator is then presented with a listing of all the stations in the system. The administrator also may be presented with the pertinent information associated with each station. The listing may contain, but need not be limited to, a summary of the definition of each station, including the name of the station, the number assigned to each station, and the station master for each station. The listing may be modified to present any and all pertinent station information contained in the system. To edit the parameters of an existing station, the administrator must select the appropriate station 536 and then select the edit field 538. The administrator will then be presented with a listing of the station and it's associated data. The name of the station will be presented, but may not be altered in the edit function. However, other fields of the record may be edited at this time. The administrator is queried for changing the station description 540 and may amend the description information for the description of the station 542. The administrator is then queried regarding changing the assigned station master 544 and may select a new station master from a menu of available users and administrators 546. The administrator is queried if they want to reassign the leads in the station to an alternative user 548, and may also select from a list of available users to whom they may want to reassign leads in the station 550. In addition, the administrator may select to amend the workflow definitions by changing the list of allowable subsequent stations. Accordingly, the administrator has the ability to amend the configuration of each station in the workflow.

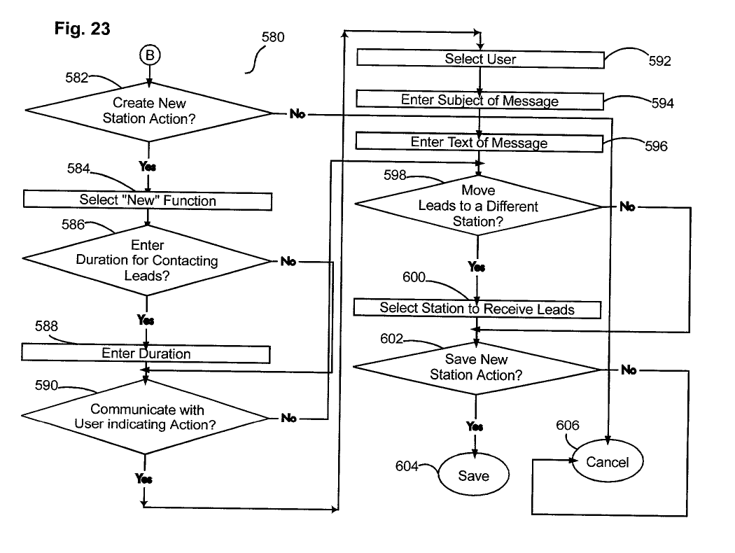

An amendment to a station action includes creating a new action 554, removing an existing action 558, and changing the order of station actions 556. A station action is the proactive process or action required of the user of a particular station with regard to each lead in the station. The administrator is given a summary of station actions with a listing of each action and it's associated proactive measure and duration. If the administrator wants to create a new station action, they select the new action field. The administrator will then be presented with the flow process which is described in further detail in FIG. 23. If the administrator selects to remove a specific action, they must select the appropriate field followed by the delete field. The administrator is then prompted to confirm the removal of the action from the station. Upon confirmation, the selected station is removed from the workflow. Finally, the administrator can select to change the order of the actions associated with each station. The administrator must select the appropriate field and then must select to either move the action up in order or down in order, by selecting the appropriate move field. When the administrator is finished editing the parameters of the selected station, with the exception of adding a new station action, the administrator may select to either save 562 or cancel 564 the changes. Upon confirmation, the amended parameters of the station is added to the workflow.

FIG. 23 is a flow chart 580 illustrating the process of adding a new station action to an existing station. The administrator selects the new station function 584. Thereafter, the administrator is presented with fields for adding a new action selection to the selected station. The administrator may then configure the new action selection to instruct the user of the station to wait a specific number of days before contacting a lead 586, 588 within the station that is subject to the new action selection when that action selection is active on the lead. This new action may be configured within the station to occur in a defined order sequence with other action selections assigned to the station. In this manner, any action selection within a station can be configured to act as a first action in the station or as a subsequent action following a prior action on the lead.

In addition, the administrator may select to have the user send an electronic mail communication or other form of notice to selected recipients 590 when specified action selections occur or fail to occur in set time frames. For example, the administrator may select the users to receive an electronic mail message 592, enter the subject of the message 594, and the text of the message itself 596. Accordingly, the administrator may configure the system and specified actions to result in multiple configurations of notices being sent via various specified communications formats selected by the administrator to various specified recipients also selected by the administrator upon the occurrence of failure in occurrence of a selected action.

The administrator may also select to amend the workflow in the system by having the leads in the station moved to a different subsequent station 598 upon the occurrence of a designated action or actions. To conduct this action, the administrator selects a subsequent station from a menu of available subsequent stations 600 during the configuration of the action. When the administrator is finished adding a new action to the selected station, the administrator may select to either save 602, 604 or cancel 606 the changes by selecting the appropriate field. Upon confirmation, the parameters of the new station action are added to the station in the existing workflow. Accordingly, the administrator has the authority to both create and amend the workflow parameters through the use of a wide variety of options available in the action configuration.

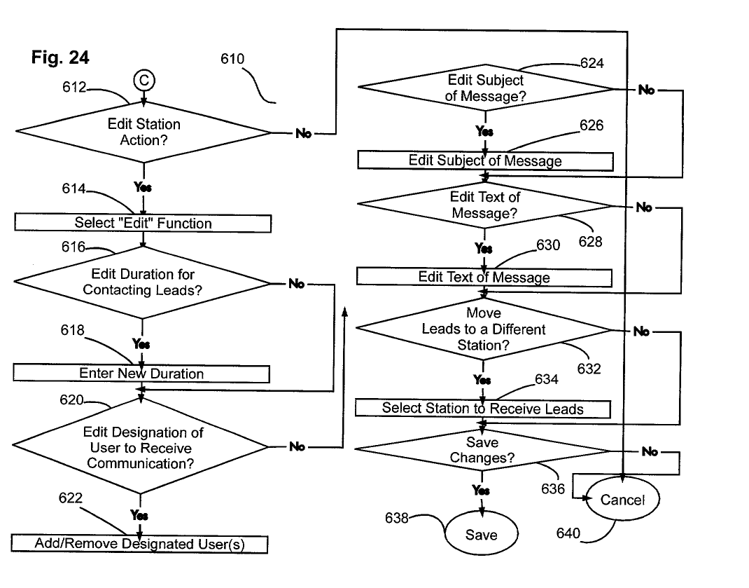

In addition to creating a new station action, the administrator can edit an existing station action. FIG. 24 is a flow chart 610 illustrating the process for editing a station action. The administrator is queried to edit a station action 612. If the administrator wants to edit an action, they must select an edit function 614. Otherwise, the administrator should select to exit this exercise by selecting a cancel function 640. Thereafter, the administrator is queried as to whether they should changes the duration for the user of the station to contact the leads therein 616, and if so to enter a new duration 618. In addition, the administrator can amend a user designated to receive any communications regarding leads in the station 620. The administrator must then add or remove any designated user 622. The administrator may also change the subject matter of the communication 624, 626, amend the text of the communication 628, 630, and move the leads in the station to a different subsequent station 632 by selecting a different station in the workflow 634. Following any of the above changes, the administrator must decided whether or not to save the changes to the station action 636. By selecting the save function 638, any changes will be saved in the system. Alternatively, the administrator can select to cancel any of the changes 640 made. Accordingly, the administrator can amend the parameter of a station action within the workflow.

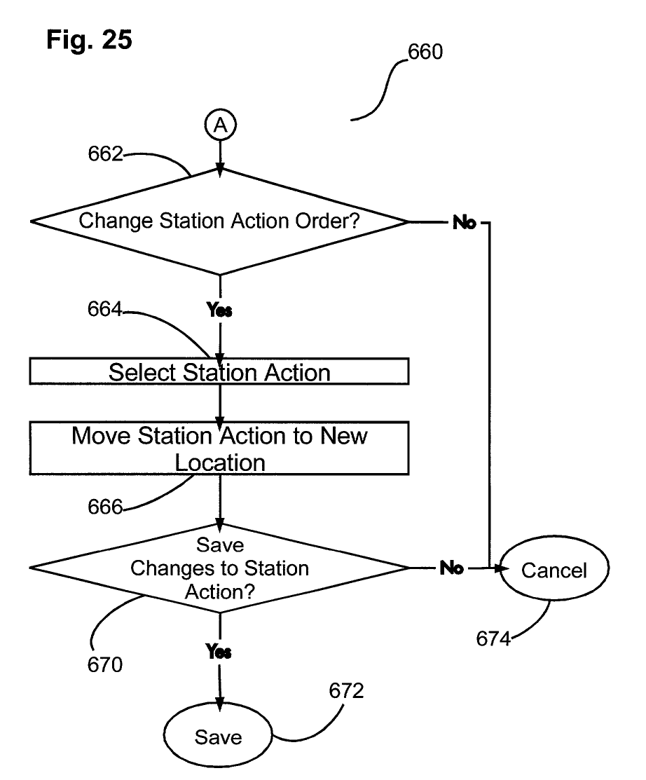

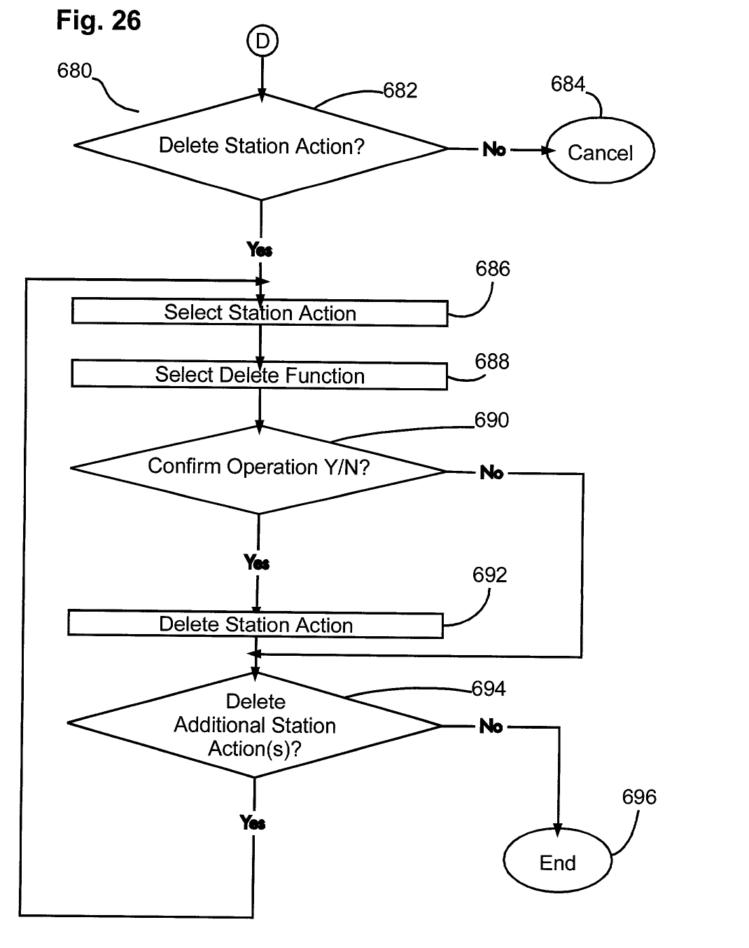

The remaining options available to the administrator with respect to the workflow arrangement is the option of changing the station action order as shown in FIG. 25, and to remove a station action from the workflow as shown in FIG. 26. Once the workflow has been established, the administrator can change the order of the actions associated with any of the stations. Each station may require a plurality of actions to be conducted by the user on each of the leads in the station at any given time. FIG. 25 is a flow chart 660 illustrating the process for changing the order of actions in a station in the workflow. From a positive reply to step 552 in FIG. 22, the administrator is queried as to whether they would like to change the order of the station actions in any one station 662. If the administrator has a negative response to the query, they can exit this step by proceeding to a cancel function 674. Alternatively, the administrator can decide that they do want to change the order of the station actions. The administrator must then select a station action 664 and move the station action to a new location 666. Thereafter, the administrator may be prompted to save the changes made to the order of the station actions 670. The administrator can then select to either save the changes made to the workflow 672, or to cancel any of the changes made to the workflow 674. Accordingly, the administrator has the authority to amend the order of the station actions in the workflow.

Complementary to amending the order of execution of actions is the process for removing a station action from the workflow. FIG. 26 is a flowchart 680 illustrating the process for removing a station action from a station in the workflow. From a positive reply to step 558 in FIG. 22, the administrator is queried as to whether they would like to remove a station action in any one station 682. If the administrator has a negative response to the query, the can exit this step by proceeding to a cancel function 684. Alternatively, the administrator can decide that they do want to remove a station action from the workflow. The administrator must then select a station action 686 followed by selection of a delete function 688. Thereafter, the administrator may be prompted to save the changes made to the station action. The administrator can then select to either save the changes made to the workflow 690, which will result in the removal of the action from the workflow, or to cancel any of the changes made to the workflow. A positive reply to the confirmation 690 will result in the removal of the station action from the workflow. Thereafter, the administrator can select to remove additional station actions 694, which will require a repetition of steps 686-690. Accordingly, the administrator has the authority to remove a station action from the workflow.

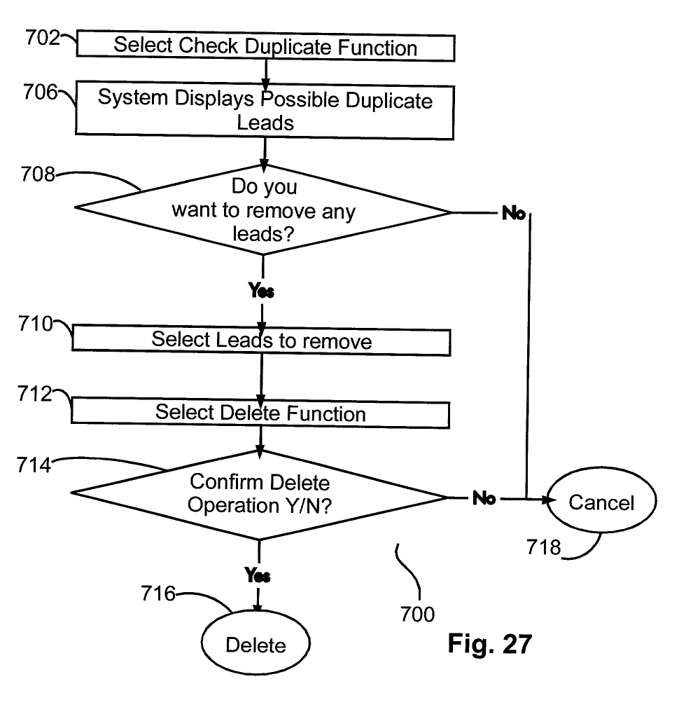

The ability to amend the workflow is an important duty assigned to the administrator. The workflow is the baseline for the marketing opportunity. However, the placement of leads in the workflow and the ability to manage duplicate leads is another important function of the administrator. FIG. 27 is a flow chart 700 demonstrating how an administrator checks a specific opportunity for duplicate records. Initially, the administrator selects a function to check for duplicate lead records 702. The administrator is presented with a list of leads that possess predefined characteristics of possible duplicates 706. For example, in presenting a duplicate lead to the user, the database searches for records where the street address is a duplicate, or the name of the lead is a duplicate. The list of duplicates is not necessarily accurate and should be reviewed to make sure that there are no duplicate records in a single opportunity. The administrator is then queried as to whether they would like to remove any of the lead records that appear to be a duplicate of another lead record 708. If the response of the administrator is positive, they must select the lead records that they want removed from the database 710, followed by a selection of the delete function 712. Before any of the selected lead records are removed from the database, the administrator will be prompted to confirm the removal of the records 714. A positive response 716 will remove the selected records, and a negative response 718 will cancel the selection. Accordingly, the process of removing duplicate records enables a marketing opportunity to run more efficiently.

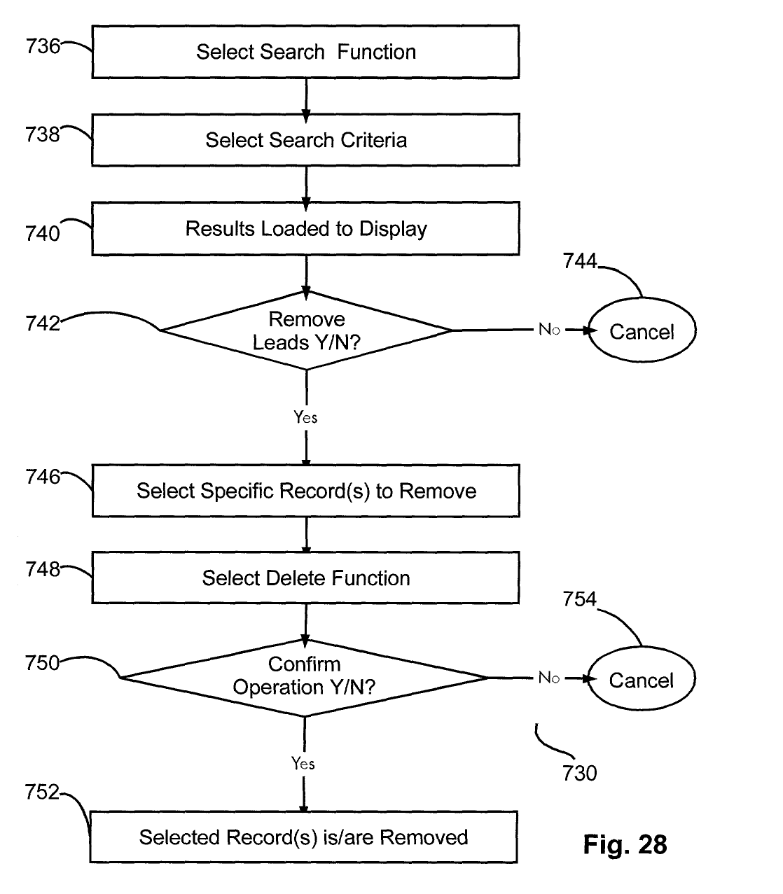

Like account users, administrators may also search the contents of the database. However, among the options available to an administrator searching the database is the ability to also remove lead records from the database. FIG. 28 is a flowchart 730 illustrating how an administrator can search the lead records of the database and remove select lead records from the database. Similar to the user, the administrator selects a search function 736, and then selects specific criteria 738, or no limiting criteria for searching the database. Thereafter, the administrator is presented with a list of the search results 740. The administrator is then queried for removal of lead records from the database 742. If the administrator wants to remove specific lead records, the administrator merely selects specific lead records 746 and then selects a delete function 748. A confirmation box will be presented to the administrator to request confirmation of the removal of the records from the database 750. The administrator may either confirm removal of the records 752, or select not to have the records removed 754 from the database. With either selection 752 or 754, the display illustrating the search results will present the updated results. Accordingly, only the administrator has the authority to remove records from the database by this function.

### Advantages over the Prior Art

The automated capabilities of storing, managing and moving prospect and customer information in a multi-person, global network-based environment has not previously been embodied in a software environment. Providing such a system can enable an organization the ability to be more responsive, and overall more organized when dealing with a multiplicity of contacts and status among contacts.

### Alternative Embodiments

It will be appreciated that, although specific embodiments of the invention have been described herein for purposes of illustration, various modifications may be made without departing from the spirit and scope of the invention. In particular, customized fields may be added to the records of the database. This allows the system to be customized for each organization and to meet their specific needs. In addition, the system may include a schedule function to be used by users, Station Masters, and administrators. The schedules allows any user of the system to set personal reminders, such as setting a date and/or time, prioritizing tasks, activity lists, description section, and a completion indication. The personal reminders can also be attached to a specific record, or to a plurality of records. The activity lists include task selection from the group consisting of: sending an electronic message, sending a facsimile correspondence, sending a correspondence and/or package via postage, and scheduling a meeting, an appointment, a demonstration, a presentation, and a preparation. Accordingly, the scope of protection of this invention is limited only by the following claims and their equivalents.

I claim:

1. A method for marketing comprising:
(a) creating a plurality of records in a database;
(b) customizing a workflow parameter;
(c) managing said records in said workflow; and
(d) acting upon said records in said workflow within a station parameter.

2. The method of claim 1, further comprising selecting a subsequent station within said workflow for said record.

3. The method of claim 1, wherein the step of customizing a workflow parameter includes assigning a duration for a record to remain in a station.

4. The method of claim 1, wherein the step of customizing a workflow parameter includes defining a subsequent station for a record.

5. The method of claim 1, wherein the step of customizing a workflow parameters includes creating an action to be conducted by a user upon said record.

6. The method of claim 1, further comprising compiling a report of said records.

7. The method of claim 6, wherein said report includes parameters selected from the fields of said record.

8. The method of claim 6, wherein said report is an automatically generated report.

9. The method of claim 8, further comprising setting a frequency for generating said automatically generated report.

10. The method of claim 8, further comprising selecting a medium for communicating said report.

11. The method of claim 10, wherein said medium is selected from the group consisting of: electronic mail, a print copy, and a hyperlink to a browser page.

12. The method of claim 1, further comprising creating an opportunity within said workflow for marketing an item.

13. The method of claim 12, wherein said opportunity includes workflow parameters for the item.

14. The method of claim 1, wherein each record is defined by an originating source.

15. The method of claim 14, further comprising said source providing a selection of originating stations in said workflow.

16. The method of claim 1, wherein the step of customizing a workflow parameter includes an administrator amending station definitions.

17. The method of claim 1, further comprising resolving a duplicate record.

18. The method of claim 1, further comprising removing said records from said database.

19. The method of claim 1, further comprising removing a user from said database.

20. The method of claim 19, wherein the step of removing said user includes reassigning records from said user to another user.

21. The method of claim 1, further comprising importing multiple records from an external source.

22. The method of claim 21, wherein the step of importing includes creating a file import map within the parameters of the database.

23. A computer system for marketing comprising:
a plurality of records in a database;
a workflow parameter adapted to be customized;
a workflow to manage said records;
wherein said workflow parameter instructs a user of a required action on a record.

24. The system of claim 23, further comprising an instruction to select a subsequent station within said workflow of said record.

25. The system of claim 23, wherein said workflow parameter defines an action to be conducted by a user upon said record during said duration.

26. The system of claim 23, further comprising an instruction to compile a report of said records.

27. The system of claim 26, wherein said report includes parameters selected from the fields of said records.

28. The system of claim 26, wherein said report is an automatically generated report.

29. The system of claim 28, further comprising an instruction to set a frequency to generate said report.

30. The system of claim 26, further comprising an instruction to set a medium to communicate said report.

31. The system of claim 30, wherein said medium is selected from the group consisting of: electronic mail, a print copy, and a hyperlink to a browser page.

32. The system of claim 23, further comprises an instruction to create an opportunity within said workflow to market an item.

33. The system of claim 23, wherein each record is defined by an originating source.

34. The system of claim 33, wherein said source provides a selection of originating stations to said records in said workflow.

35. The system of claim 23, wherein said workflow parameter is amended by a system administrator.

36. The system of claim 23, further comprising an instruction to resolve duplicate records.

37. The system of claim 23, further comprising an instruction to remove records from said database.

38. The system of claim 23, further comprising an instruction to remove a user from said workflow.

39. The system of claim 38, wherein said instruction includes a secondary instruction to reassign records of said user to another user of said system.

40. The system of claim 23, further comprising in instruction to import multiple records form an external source.

41. The system of claim 40, further comprising an import map to facilitate said import of records.

42. A method for marketing comprising:
(a) creating a plurality of records in a database;
(b) customizing a workflow parameter;
(c) managing said records in said workflow;
(d) acting upon said records in said workflow within a station parameter;
(e) selecting a subsequent station within said workflow for said record.

43. The method of claim 42, further comprising compiling a progress report of said records;

44. The method of claim 43, further comprising selecting a medium for communicating said report.

45. The method of claim 43, wherein said report is an automatically generated report produced at a specified frequency.

46. The method of claim 42, further comprising entering new records into the database.

47. The method of claim 46, wherein said records are imported from an external source.

48. The method of claim 47, further comprising compiling an import map to convert a format of external source to said database.

49. The method of claim 42, further comprising adding custom fields to the record of the database.

50. The method of claim 42, further comprising providing a personal reminder schedule for a user of the database.
